(19) United States
(12) Patent Application Publication
(10) Pub. No.: US 2024/0239441 A1
(43) Pub. Date: Jul. 18, 2024

(54) CONTINUOUSLY VARIABLE TRANSMISSION UNIT, PREFERABLY FOR A BICYCLE

(71) Applicant: CLASSIFIED CYCLING BV, Antwerpen (BE)

(72) Inventor: Roëll Marie VAN DRUTEN, Eindhoven (NL)

(21) Appl. No.: 18/564,296

(22) PCT Filed: Apr. 25, 2022
(86) PCT No.: PCT/EP2022/060920

§ 371 Date: Nov. 27, 2023

(30) Foreign Application Priority Data
May 28, 2021 (NL) 2028336
Jul. 9, 2021 (NL) 2028685
Jul. 9, 2021 (NL) 2028686
Jul. 26, 2021 (NL) 2028836
Dec. 23, 2021 (NL) 2030258
Dec. 23, 2021 (NL) 2030261
Mar. 1, 2022 (NL) 2031121
Mar. 1, 2022 (NL) 2031123

(51) Int. Cl. B62M 9/08

(52) U.S. Cl. CPC B62M 9/085

(57) ABSTRACT

The disclosure relates to a continuously variable transmission (CVT) unit. The CVT unit comprises a first drive element that is rotatable about a first axis and a second drive element that is rotatable about a second axis parallel to the first axis, wherein the first drive element and the second drive element are movable relative to each other in a direction transverse to the first and second axis. The CVT unit further comprises first coupling elements provided at a constant first radius from the first axis and at a variable second radius from the second axis, for transferring torque between the first drive element and the second drive element.

### FIELD

The invention relates to a continuously variable transmission unit, such as for a bicycle transmission.

### BACKGROUND

Transmission systems, e.g. for vehicles, windmills etc., are known. In bicycles, especially racing bicycles, the transmission system traditionally includes a front derailleur and a rear derailleur, for shifting gears of the transmission system. An alternative to derailleurs is formed by gear hubs, where shifting of gears is accommodated by a gear shifting mechanism inside the, generally rear, wheel hub. A hybrid form is known where a gear hub torque transmission having at least two selectable gear ratios is coupled between the rear wheel hub and the rear sprocket. Herein the rear sprocket can include a plurality of gear wheels, selectable through a rear derailleur. Here the gear hub can take the place of a front derailleur.

Such gear hub can include one or more planetary gear sets. The planetary gear includes at least three rotational members, such as a sun gear, a planet carrier and a ring gear. A clutch or brake system can be used for selectively coupling two of the rotational members, e.g. the planet carrier and the ring gear. When coupled, the hub gear shifting mechanism operates according to a first gear ratio. When decoupled, the hub gear shifting mechanism operates according to a second gear ratio.

### SUMMARY

According to an aspect a continuously variable transmission (CVT) unit is provided. The CVT unit can be used for various vehicles. The CVT unit comprises a first drive element that is rotatable about a first axis, and a second drive element that is rotatable about a second axis parallel to the first axis. The first drive element and the second drive element are movable relative to each other in a direction transverse to the first and second axis. The CVT unit includes first coupling elements provided at a constant first radius from the first axis and at a variable second radius from the second axis. The first coupling elements are provided for transferring torque between the first drive element and the second drive element. The first drive element and the second drive element are movable relative to each other in a direction transverse to the first and second axis for transferring torque. By varying the relative displacement between the first axis and the second axis, the variable second radius at which torque is transferred between the first and second drive elements is varied. Hence, various transmission ratios can be obtained between the first and second drive elements. Hence, various transmission ratios can be obtained between an input and an output of the CVT unit.

Optionally, the first coupling elements are coupled to the second drive element in a tangential direction, and movable relative to the second drive element in a radial direction. Thus, the first coupling elements can move radially relative to the second axis, while remaining tangentially coupled to the second drive element. Optionally, the first coupling elements are coupled to the first drive element in a radial direction at the first radius, and movable relative to the first drive element in a first tangential direction. Optionally, the first coupling elements are couplable to the first drive element in a second tangential direction opposite the first tangential direction. Thus, the first coupling elements can be maintained at a predetermined radial distance relative to the first axis. The first coupling elements can e.g. be freely movable in the first tangential direction relative to the first drive member and couple to the first drive element in the second tangential direction relative to the first drive member. Hence, the first drive element can drive the first coupling elements in rotation in the first tangential direction, and the first drive element can freely move in the second tangential direction relative to the first coupling elements. Also, the first coupling elements can drive the first drive element in rotation in the second tangential direction, and the first coupling elements can freely move in the first tangential direction relative to the first drive element.

Optionally, the first drive element comprises a first concentric guide extending concentrically around the first axis, wherein the first concentric guide is arranged for guiding a movement of the first coupling elements in the first tangential direction. The first concentric guide may for example be a slot provided in the first drive element, which slot concentrically extends around the first axis.

Optionally, the first concentric guide and the first coupling elements form or include a one-way coupling for allowing movement of the first coupling elements relative to the first concentric guide in the first tangential direction, and for blocking movement of the first coupling elements relative to the first concentric guide in the second tangential direction. Each of the first coupling elements may for example comprise a one-way unit which is arranged to be wedged between an inner race and an outer race of the first concentric guide when driven in the second tangential direction.

Optionally, each of the first coupling elements comprises a wedging body which is tiltable about a tilt axis between a neutral position in which free movement of the coupling element relative to the first concentric guide is allowed, and a wedged position in which the wedging body is wedgingly engaged with the first concentric guide. For example the wedging body may be wedged between two races of the first concentric guide, e.g. between in inner race and an outer race. It will be appreciated that the neutral position and the wedged position may differ only slightly, e.g. a few micrometers at the extreme points. For assuming the neutral position it is sufficient that the wedging body is no longer wedgingly engaged with the first concentric guide.

Optionally each of the first coupling elements comprises at least one roller for activating the tilting of the wedging body from the neutral position to the wedged position.

Optionally, a first end of the wedging body is provided with a converging wedging recess for cooperating with a first roller and a second end of the wedging body, opposite the first end, is provided with a diverging wedging recess for cooperating with a second roller. Here converging and diverging are defined as seen in a direction away from the centre of the wedging body. With respect to a freewheel direction of the wedging bodies, the converging wedging recess may be provided at a leading end of the wedging bodies, and the diverging recess may be provided at a trailing end of the wedging bodies. The first roller may for example be provided between an inner race of the first concentric guide and a converging wedging face of the converging wedging recess. The second roller may for example be provided between an outer race of the first concentric guide and a diverging wedging face of the diverging wedging recess. Optionally, the first and/or the second roller is biased, e.g. elastically, e.g. with a spring, in a wedging direction. The first and/or the second roller can be biased towards the converging side of the wedging recesses. This provides the advantage that the wedging body is biased in a wedged state, and can be released by movement in the freewheel direction.

Optionally, the second drive element comprises first radial guides extending at least radially with respect to the second axis, i.e. having a radial component. The first radial guides are arranged for guiding movement of the first coupling elements in radial direction and for transmitting torque in tangential direction. The first radial guides may comprise radially extending slots in a body of the second drive element.

Optionally, each of the first coupling elements comprises a guide wheel for running along the first radial guides.

Optionally, the first coupling elements are movably, such as hingedly, connected to the second drive element for allowing a radial movement of the first coupling elements relative to the second drive element.

Optionally, each wedging body is tiltable about a tilt axis between a neutral position in which free movement of the coupling element relative to the first concentric guide is allowed, and a wedged position in which each wedging body is wedgingly engaged with the first concentric guide.

Optionally, each of the first coupling elements comprises two wedging bodies. Optionally, each wedging body of the first coupling element is tiltable about a common tilt axis between a neutral position in which free movement of the coupling element relative to the first concentric guide is allowed, and a wedged position in which each wedging body is wedgingly engaged with the first concentric guide.

Optionally, the guide wheel is rotatable about the common tilt axis, wherein the two wedging bodies are arranged on either side of the guide wheel.

Optionally, the continuously variable transmission unit comprises a third drive element that is rotatable about a third axis parallel to the second axis. The third drive element and the second drive element can be movable relative to each other in a direction transverse to the third and second axis. The CVT can include second coupling elements provided at a constant third radius from the third axis and at a variable fourth radius from the second axis, for transferring torque between the third drive element and the second drive element. Hence, torque can be transmitted from the first drive element to the second drive element according to a first CVT transmission ratio, and from the second drive element to the third drive element according to a second CVT transmission ratio. The first and second CVT transmission ratios are particularly serially arranged, and hence a CVT unit transmission ratio step obtainable with the CVT unit can be increased. Optionally, the constant first radius corresponds to the constant third radius, i.e. the constant first radius and the constant third radius are equal. Optionally, the variable second radius corresponds to the variable fourth radius, i.e. the variable second radius and the variable fourth radius are equal.

Optionally, the second coupling elements are coupled to the second drive element in a tangential direction, and movable relative to the second drive element in a radial direction. Thus, the second coupling elements can move radially relative to the second axis, while remaining tangentially coupled to the third drive element. Optionally, the second coupling elements are coupled to the third drive element in a radial direction at the constant third radius, and movable relative to the third drive element in a fourth tangential direction. Optionally the second coupling elements are couplable to the third drive element in a third tangential direction opposite the fourth tangential direction. Optionally, the third tangential direction corresponds to the first tangential direction, i.e. the third and first tangential directions are the same. Optionally, the fourth tangential direction corresponds to the second tangential direction, i.e. the fourth and second tangential directions are the same. Thus, the second coupling elements can be coupled to the third drive element in a radial direction at the third radius, and movable relative to the third drive element in the second tangential direction, and the second coupling elements are couplable to the third drive element in the first tangential direction. Hence, the second coupling elements can drive the third drive element in rotation in the first tangential direction, and the second coupling elements can freely move in the second tangential direction relative to the third drive element. Also, the third drive element can drive the second coupling elements in rotation in the second tangential direction, and the third drive element can freely move in the first tangential direction relative to the second coupling elements.

Optionally, the third drive element comprises a second concentric guide extending concentrically around the third axis, wherein the second concentric guide is arranged for guiding a movement of the second coupling elements in the third tangential direction. The second concentric guide may for example be a slot provided in the third drive element, which slot concentrically extends around the third axis.

Optionally, the second concentric guide and the second coupling elements form or include a one-way coupling for allowing movement of the second coupling elements relative to the second concentric guide in the fourth tangential direction, and for blocking movement of the second coupling elements relative to the second concentric guide in the third tangential direction.

Optionally, each of the second coupling elements comprises a wedging body which is tiltable about a tilt axis between a neutral position in which free movement of the coupling element relative to the first concentric guide is allowed, and a wedged position in which the wedging body is wedgingly engaged with the second concentric guide. For example the wedging body may be wedged between two races of the second concentric guide, e.g. between in inner race and an outer race. It will be appreciated that the neutral position and the wedged position may differ only slightly, e.g. a few micrometers at the extreme points. For assuming the neutral position it is sufficient that the wedging body is no longer wedgingly engaged with the first concentric guide.

Optionally each of the second coupling elements comprises at least one roller for activating the tilting of the wedging body from the neutral position to the wedged position.

Optionally, a first end of the wedging body is provided with a converging wedging recess for cooperating with a first roller and at a second end of the wedging body, opposite the first end, is provided with a diverging wedging recess for cooperating with a second roller. With respect to a freewheel direction of the wedging bodies, the converging wedging recess may be provided at a leading end of the wedging bodies, and the diverging recess may be provided at a trailing end of the wedging bodies. The first roller may for example be provided between an inner race of the second concentric guide and a converging wedging face of the converging wedging recess. The second roller may for example be provided between an outer race of the second concentric guide and a diverging wedging face of the diverging wedging recess. Optionally, the first and/or the second roller is biased, e.g. elastically, e.g. with a spring, in a wedging direction. The first and/or the second roller can be biased towards the converging side of the wedging recesses. This provides the advantage that the wedging body is biased in a wedged state, and can be released by movement in the freewheel direction.

Optionally, the second drive element comprises second radial guides extending radially with respect to the second axis, wherein the second radial guides are arranged for guiding movement of the second coupling elements in radial direction and for transmitting torque in tangential direction. The second radial guides may comprise radially extending slots in a body of the second drive element.

Optionally, each of the second coupling elements comprises a guide wheel for running along the second radial guides.

Optionally, the second coupling elements are movably, such as hingedly, connected to the second drive element for allowing a radial movement of the second coupling elements relative to the second drive element.

Optionally, each wedging body is tiltable about a tilt axis between a neutral position in which free movement of the coupling element relative to the second concentric guide is allowed, and a wedged position in which each wedging body is wedgingly engaged with the second concentric guide.

Optionally, each of the second coupling elements comprises two wedging bodies. Optionally, each wedging body of the second coupling element is tiltable about a common tilt axis between a neutral position in which free movement of the coupling element relative to the second concentric guide is allowed, and a wedged position in which each wedging body is wedgingly engaged with the second concentric guide.

Optionally, the guide wheel is rotatable about the common tilt axis, wherein the two wedging bodies are arranged on either side of the guide wheel.

Optionally, the first axis and the third axis coincide. The first drive element and the third drive element may for example be rotatable about a common axis.

Optionally, the second drive element is pivotally movable about a pivot axis that extends parallel to the first and second axes, for being pivotally moved relative to the first drive element in a direction transverse to the first and second axis. Hence, the second drive element can be moved relative to the first drive element by a rotary drive about the pivot axis.

Optionally the transmission unit comprises a second transmission wheel concentrically coupled to the second drive element and corotatable therewith about the second axis; and a first transmission wheel drivingly connected to the second transmission wheel for transmitting torque between the first and second transmission wheels, wherein the first transmission wheel has a rotation axis that coincides with the pivot axis. The first transmission wheel and the second transmission wheel may for example be a first gear wheel and a second gear wheel respectively, wherein the first and second gear wheels mesh for transferring torque. The first transmission wheel and the second transmission wheel may alternatively be a first chain wheel and a second chain wheel respectively, connected via a chain.

Optionally, the transmission unit comprises an endless drive member, e.g. a chain or belt, drivingly engaging the first transmission wheel and the second transmission wheel for transmitting torque between the first and second transmission wheels. A gearless transmission unit can hence be obtained. Also, for example, when driving the first drive member in rotation about the first axis, the driving force is transferred by the first coupling elements to the second drive element. This force acts on the second drive element in substantially opposite direction as a reaction force from the endless drive member. Hence, an actuation force for moving the second drive element relative to the first drive element can be reduced, at least with respect to a geared drive arrangement.

Optionally, the transmission unit is arranged for pivoting the second drive element between a concentric position in which the first and second axes coincide and an eccentric position in which the first and second axes are offset, and wherein if the first drive element drives the second drive element in a driven rotation direction about the second axis the transmission unit is arranged for pivoting the second drive element from the concentric position to the eccentric position in a rotation direction about the pivot axis opposite the driven rotation direction; and if the second drive element drives the first drive element in a driven rotation direction about the first axis the transmission unit is arranged for pivoting the second drive element from the concentric position to the eccentric position in the driven rotation direction about the pivot axis. Hence, an actuation force for moving the second drive element relative to the first drive element can be minimised.

Optionally, e.g. alternatively, or additionally, the first drive element is pivotally movable about a pivot axis that extends parallel to the first and second axes, for being pivotally moved relative to the second drive element in a direction transverse to the first and second axis. Then the transmission unit can arranged for pivoting the first drive element between a concentric position in which the first and second axes coincide and an eccentric position in which the first and second axes are offset, and wherein if the second drive element drives the first drive element in a driven rotation direction about the second axis the transmission unit is arranged for pivoting the first drive element from the concentric position to the eccentric position in a rotation direction about the pivot axis opposite the driven rotation direction; and if the first drive element drives the second drive element in a driven rotation direction about the first axis the transmission unit is arranged for pivoting the first drive element from the concentric position to the eccentric position in the driven rotation direction about the pivot axis. Hence, an actuation force for moving the first drive element relative to the second drive element can be minimised.

Optionally, the transmission unit comprises a pivot arm for coupling the first transmission wheel to the second transmission wheel and delineate a constant distance between the second axis and the pivot axis, the pivot arm extending between a first end at which the pivot arm couples to the first transmission wheel at the pivot axis, and a second end at which the pivot arm couples to the second transmission wheel at the second axis. Because, the first transmission wheel is rotatingly associated with the pivot axis, and the second transmission wheel with the second axis, the first and second transmission wheel can remain drivingly engaged while pivoting second transmission wheel along with the second drive member relative to the first transmission wheel, e.g. directly meshingly engaged or via an endless drive member such as a belt or chain.

Optionally, the transmission unit comprises a fourth transmission wheel concentrically coupled to the second drive element and corotatable therewith about the second axis; and a third transmission wheel drivingly connected to the fourth transmission wheel for transmitting torque between the third and fourth transmission wheels, wherein the third transmission wheel has a rotation axis that coincides with the pivot axis.

Optionally, a torque transmission between first and second transmission wheels defines a first transmission path, and a torque transmission between the third and fourth transmission wheels defines a second transmission path, parallel to the first transmission path; and the transmission system comprises a clutch for switching the torque transmission from the first transmission path to the second transmission path and/or vice versa. The clutch may particularly be a load-shifting clutch, arranged for shifting under load, for example as described in WO2018/199757A2, WO2020/085911A2, or WO2021/080431A1.

According to an aspect, a hub assembly and/or a crank assembly for a bicycle is provided, comprising a continuously variable transmission unit as described herein.

Optionally, the hub assembly comprises a hub shell for coupling to a driven wheel of the bicycle, the hub shell being coupled to the first drive element and corotatable therewith about the first axis; and a sprocket concentrically coupled to the second drive element and corotatable therewith about the second axis. Alternatively, the hub assembly comprises a hub shell for coupling to a driven wheel of the bicycle, the hub shell being coupled to the second drive element and corotatable therewith about the second axis; and a sprocket concentrically coupled to the first drive element and corotatable therewith about the first axis.

Optionally, the hub assembly comprises a hub shell for coupling to a driven wheel of the bicycle, the hub shell being coupled to the first drive element and corotatable therewith about the first axis; and a sprocket coupled to the third drive element and corotatable therewith about the third axis.

Optionally, the crank assembly further comprises a first transmission, wherein the continuously variable transmission unit and the first transmission are connected in series; the first transmission being selectively operable according to a first transmission ratio or a second transmission ratio, and having a first clutch for switching the first transmission from the first transmission ratio to the second transmission ratio and/or vice versa.

Optionally, the crank assembly further comprises a second transmission, wherein the continuously variable transmission unit, the first transmission and the second transmission are connected in series; the second transmission being selectively operable according to a third transmission ratio or a fourth transmission ratio, and having a second clutch for switching the second transmission from the third transmission ratio to the fourth transmission ratio and/or vice versa.

According to an aspect, a vehicle is provided comprising a transmission unit as described herein. In particular, a bicycle is provided comprising a transmission unit as described herein. The bicycle for example comprises a hub assembly and/or a crank assembly which includes a continuously variable transmission unit as described herein.

According to an aspect is provided a gearless transmission unit such as for a bicycle, providing at least two discrete selectable transmission ratios, wherein a first of the at least two transmission ratios is provided by a first endless drive member, and wherein a second of the at least two transmission ratios is provided by a second endless drive member.

Optionally, the first and second endless drive members are placed in parallel between an input and an output of the gearless transmission unit, and the gearless transmission unit includes a selector for selecting power transmission via the first or the second endless drive member.

Optionally, the gearless transmission unit includes a clutch for selecting power transmission via the first endless drive member or the second endless drive member.

Optionally, the gearless transmission unit further includes a third endless drive member and a fourth endless drive member, wherein the third and fourth endless drive members are placed in parallel between an output of the first and second endless drive members and an output of the gearless transmission unit, and the gearless transmission unit includes a selector for selecting power transmission via the third or the fourth endless drive member.

Optionally, the gearless transmission unit includes a clutch for selecting power transmission via the third endless drive member or the fourth endless drive member.

Optionally, the clutch is arranged to be coupled and/or decoupled under load. The clutch is for example a load-shifting clutch.

Optionally, at least one of the first, second, third and fourth endless drive members is non-lubricated. In particular, each endless drive member of the gearless transmission unit may be non-lubricated. Hence, no lubrication fluid is provided on at least one of the first endless drive member, the second endless drive member, the third endless drive member and the fourth endless drive member, particularly on all four of said endless drive members. A dry drive system can hence be obtained.

Optionally, the at least one of the first, second, third and fourth endless drive members comprises, e.g. is, a dry belt or a dry chain.

Optionally, at least one of the first, second, third and fourth endless drive members comprises a lubricated chain. In particular, and as alternative to a dry drive system, each endless drive member of the gearless transmission unit may be lubricated, e.g. with a lubrication fluid such as an oil.

Optionally, the gearless transmission unit includes a continuously variable transmission, e.g. a continuously variable transmission as described herein.

According to an aspect, each of the transmission ratios provided by the transmission system as described herein is oil-free, preferably lubrication-free.

According to an aspect is provided a hub assembly for a bicycle including the gearless transmission unit.

According to an aspect is provided a crank assembly for a bicycle including the gearless transmission unit.

According to an aspect is provided a distributed transmission system for a bicycle, comprising a crank transmission including the CVT as described herein and optionally the first transmission as described herein and a hub transmission comprising the second transmission as described herein. It will be appreciated that alternatively the crank transmission may including the second transmission as described herein and the hub transmission may comprise the first transmission as described herein.

It will be appreciated that any one or more of the above aspects, features and options can be combined. It will be appreciated that any one of the options described in view of one of the aspects can be applied equally to any of the other aspects. It will also be clear that all aspects, features and options described in view of the transmissions unit apply equally to the hub and crank assembly.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIGS. 1A-1D show a schematic example of a continuously variable transmission unit;

FIG. 2 shows a perspective view of an exemplary continuously variable transmission unit;

FIGS. 3A-3C perspective views of exemplary components of a continuously variable transmission unit;

FIGS. 4A-4D show cross sectional views of an exemplary continuously variable transmission unit;

FIGS. 5A-5B show a schematic layout of a transmission system comprising an exemplary continuously variable transmission unit;

FIGS. 6A-6B show a schematic layout of a transmission system comprising an exemplary continuously variable transmission unit;

FIG. 7 shows a schematic layout of a transmission system comprising an exemplary continuously variable transmission unit;

FIGS. 8A-8B show a schematic layout of a transmission system comprising exemplary continuously variable transmission unit;

FIG. 9 shows a schematic example of a transmission system comprising a continuously variable transmission unit;

FIGS. 10A-10B show a schematic layout of a transmission system comprising exemplary continuously variable transmission unit;

FIG. 11 shows a schematic layout of a transmission system comprising an exemplary continuously variable transmission unit;

FIG. 12 shows a schematic layout of a transmission system comprising an exemplary continuously variable transmission unit;

FIG. 13 shows a schematic layout of a transmission system comprising an exemplary continuously variable transmission unit;

FIGS. 14A-14B show a schematic layout of a transmission system comprising exemplary continuously variable transmission unit;

FIGS. 15A-15B show a schematic of a transmission system comprising a continuously variable transmission unit;

FIG. 16 shows a schematic layout of a transmission system comprising exemplary continuously variable transmission unit;

FIGS. 17A-17B show a schematic of a transmission system comprising a continuously variable transmission unit;

FIGS. 18A-18B show schematic examples of a transmission system comprising a continuously variable transmission unit;

FIGS. 19A-19B show a schematic of a transmission system comprising a continuously variable transmission unit;

FIGS. 20A-20B show a schematic of a transmission system comprising a continuously variable transmission unit;

FIGS. 21A-21B show examples of a bicycle.

### DETAILED DESCRIPTION

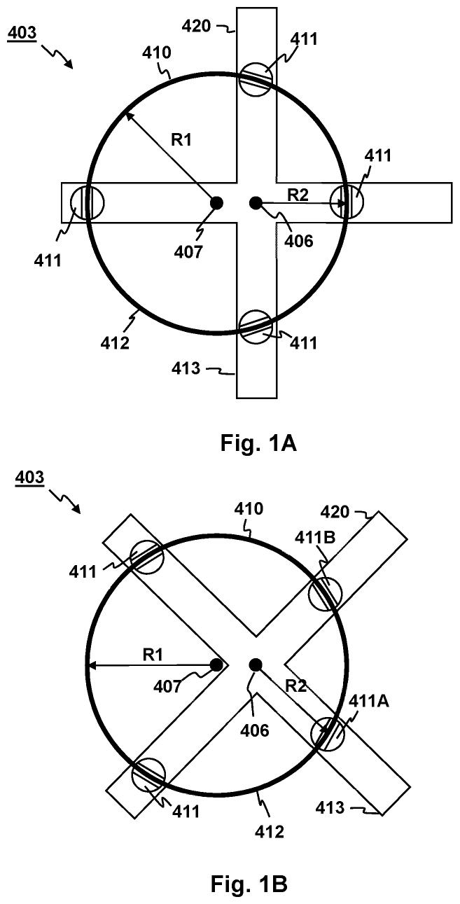

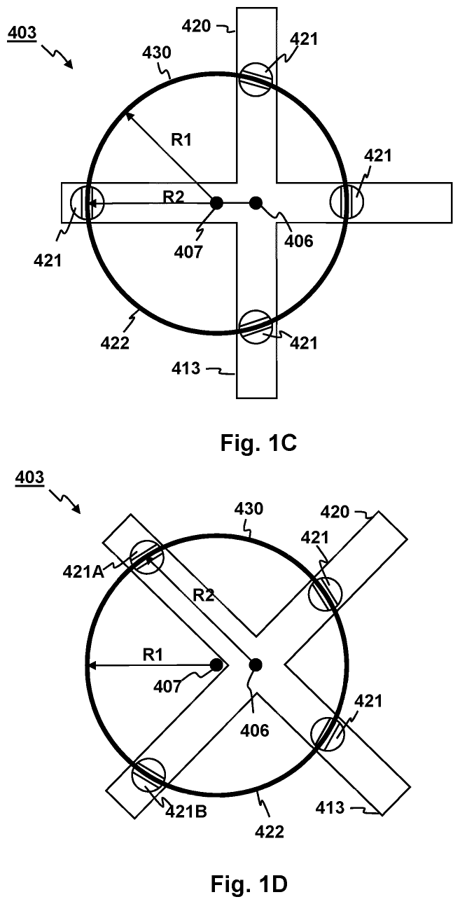

FIGS. 1A and 1B show a schematic example of a continuously variable transmission (CVT) unit 403, particularly of a ratcheting type. The CVT unit 403 includes a first drive element 410, here forming an input of the CVT unit 403, and a second drive element 420, here forming an output of the CVT unit 403. The first drive element 410 is rotatable about a first axis 407. The second drive element 420 is rotatable about a second axis 406, parallel to the first axis 407. Torque can be transmitted from the first drive element 410 to the second drive element 420 by means of first coupling elements 411. The first coupling elements 411, in this example four first coupling elements, are concentrically arranged with respect to the first axis 407, at a constant first radius R1 from the first axis 407. The first drive element 410 and the second drive element 420 are movable, e.g. translatable, relative to one another in a direction transverse to the first and second axis 407, 406, e.g. for providing an offset between the first axis 407 and the second axis 406. Torque can be transmitted from the first drive element 410 to the second drive element 420, by means of the first coupling elements 411, at a variable second radius R2 from the second axis 406. Hence, torque can be transferred from the constant first radius R1 to the variable second radius R2. Hence, various ratios between the first radius R1 and second radius R2 can be obtained, resulting in various transmission ratios between the first drive element 410 and the second drive element 420.

The first coupling elements 411 are movable with respect to the first drive element 410 in a tangential direction. The first drive 410 element in this example comprises a first concentric guide 412 which extends concentrically around the first axis 407 at the first radius R1. Tangential movement of the first coupling elements 411 about the first axis 407 is guided by the concentric guide 412. The concentric guide 412 prohibits a radial movement of the first coupling elements 411 relative to the first axis 407, for keeping the first coupling elements 411 at the constant first radius R1 from the first axis 407. The first coupling elements are thus radially coupled to the first drive element 410, relative to the first axis 407.

With respect to the first axis 407, the first coupling elements 411 are tangentially couplable to the first drive element 410. Hereto, in this example, the first coupling elements 411 and the first concentric guide 412 form or include a one-way coupling. The one-way coupling is arranged for allowing tangential movement of the first coupling elements 411 relative to the first concentric guide 412 in one direction, and for blocking tangential movement of the first coupling elements 411 relative to the first concentric guide 412 in the other, opposite, direction. Hence, the first drive element 410 can drive the first coupling elements 411 in rotation around the first axis 407 in one direction, while allowing the first coupling elements 411 to freewheel relative to the first drive element 410 in the other direction.

The first coupling elements 411 are furthermore movable relative to the second drive element 420 in a radial direction with respect to the second axis 406. In a tangential direction relative to the second axis 406, the first coupling elements 411 are coupled to the second drive element 420. The second drive element 420 particularly comprises radial guides 413, e.g. radial slots, which extend radially with respect to the second axis 406. Here, the radial guides 413 are evenly and angularly spaced from each other. The first coupling elements 411 are guided in radial direction, with respect to the second axis 406, by the radial guides 413.

In this example, CVT unit 403 comprises four first coupling elements 411 associated with four respective radial guides 413, but it will be appreciated that the CVT unit 403 can comprise more than four radial guides 413, e.g. 5, 6, 7, 8, 12, 16. Similarly, the CVT unit 403 can comprises more than four first coupling elements 411, e.g. 5, 6, 7, 8, 12, 16.

By moving the first drive element 410 relative to the second drive elements 420, in a direction perpendicular to the first and second axes 407, 406, a distance between the first axis 407 and the second axis 406 can be varied. Hence, a radius at which torque is transmitted can be varied.

In the example of FIGS. 1A and 1B, torque is transmitted from the first drive element 410 to the second drive element 420. FIGS. 1A and 1B show two relative angular positions of the first drive element 410 and the second drive element 420, with the same offset between the first axis 407 and the second axis 406. If the first drive element 410 is rotatingly driven in a driving direction about the first axis 407 (e.g. counter clockwise in this example), the first coupling elements 411 are entrained in the rotation of the first drive element 410, and hence torque can be transmitted from the first drive element 410 to the second drive element 420. If the first drive element 410 is driven in the driving direction, all first coupling elements 411 are forced to move with the first drive element 410 at a circumferential velocity that is at least equal to a circumferential velocity of the first concentric guide 412. If the first drive element 410 is driven in the driving direction, at least some of the first coupling elements 411 can move at a circumferential velocity that is higher than the circumferential velocity of the first concentric guide 412. If the first drive element 410 is rotatingly driven in a non-driving direction about the first axis 407 opposite the driving direction (e.g. clockwise in this example), freewheeling of the first coupling elements 411 is permitted, and hence no torque is transmitted from the first drive element 410 to the second drive element 420. In the driving direction of the first drive element 410, at least one of the first coupling elements 411 transmits torque by coupling tangentially to the first drive element 410.

In particular, at a point in time only one of the first coupling elements 411 transmits torque from the first drive element 410 to the second drive element 420, by coupling tangentially to the first drive element 410. The only one of the first coupling elements 411 is radially coupled to the first drive element 410 by means of the concentric guide 412, and is tangentially coupled to the second drive element 420 by means of the radial guides 413. The coupling element of the first coupling elements 411 being at a smallest second radius from the second axis 406 transmits torque. This coupling element is tangentially coupled to the first drive element 410, particularly by means of the one-way coupling of the first coupling element 411 and the concentric guide 412. The coupling element that transmits torque has the lowest tangential velocity of the first coupling elements 411. The other coupling elements are at a larger second radius R2 from the second axis 406, and therefore have a larger tangential velocity, are overrun the concentric guide 412 in tangential direction and hence do not transmit torque.

The second radius R2 from the second axis 406 at which torque is transmitted can be varied by the offset the first and second axes 407, 406.

FIG. 1B shows a situation in which the smallest second radius R2 is identical for the first coupling elements 411A and 411B. This situation constitutes the hand-over point where the first coupling element 411A just starts to transmit torque and the first coupling element 411B just stops transmitting torque.

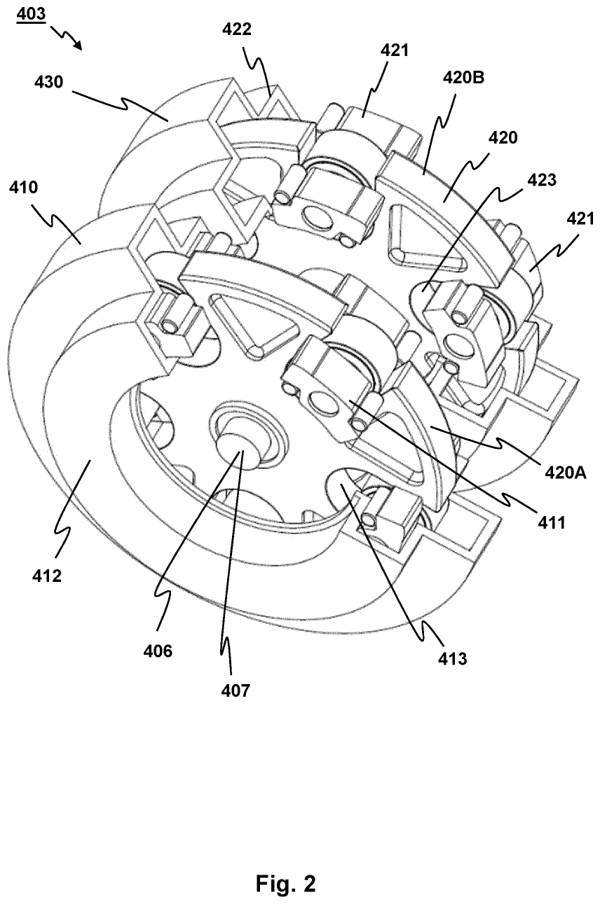

FIG. 2 shows an example of a continuously variable transmission (CVT) unit 403. The CVT unit 403 of the example of FIG. 2 comprises a first drive element 410 and a second drive element 420, and further comprises a third drive element 430. Torque can be transmitted between the first drive element 410 and the second drive element 420, and between the second drive element 420 and the third drive element 430. The third drive element 430 is similar to the first drive element 410.

The CVT unit 403 comprises first coupling elements 411 for coupling the first drive element 410 to the second drive element 420, and second coupling elements 421 for coupling the second drive element 420 to the third drive element 430.

The second drive element 420 comprises a first body 420A having the first radial guides 413 associated therewith for cooperating with the first coupling elements 411, and a second body 420B having second radial guides 423 associated therewith for cooperating with the second coupling elements 421. The first body 420A and the second body 420B are fixedly coupled to each other, and rotatable about the second axis 406.

In this example, the first drive element 410 and the third drive element 430 are both rotatable about the first axis 407. The first drive element 410 comprises a first concentric guide 412 for cooperating with the first coupling elements 411, and the third drive element 430 comprises a second concentric guide 422 for cooperating with the second coupling elements 421. When driven in the driving direction, the first drive element 410 drives the second drive element 420 via the first coupling elements 411, and the second drive element 420 drives the third drive element 430 via the second coupling elements.

If the first drive element 410 is driven in the driving direction, all first coupling elements 411 are forced to move with the first drive element 410 at a circumferential velocity that is at least equal to a circumferential velocity of the first concentric guide 412. If the first drive element 410 is driven in the driving direction, at least some of the first coupling elements 411 can move at a circumferential velocity that is higher than the circumferential velocity of the first concentric guide 412. The first coupling element 411 of the first coupling elements 411 being at a smallest second radius R2 from the second axis 406 transmits torque. The first coupling element 411 that transmits torque has the lowest circumferential velocity of the first coupling elements 411. Hence, the second drive element 420 is driven in rotation in the driving direction by the first coupling elements 411.

FIGS. 1C and 1D schematically show the second drive element 420 and the third drive element 430.

If the second drive element 420 is driven in the driving direction, the third drive element 430 is forced to move with the second coupling elements 421 at a circumferential velocity that is equal to a circumferential velocity of the fastest second coupling element 421. If the second drive element 420 is driven in the driving direction, at least some of the second coupling elements 421 can move at a circumferential velocity that is lower than the circumferential velocity of the second concentric guide 422. The second coupling element 421 of the second coupling elements 421 being at a largest second radius R2 from the second axis 406 transmits torque. The second coupling element 421 that transmits torque has the highest circumferential velocity of the second coupling elements 421. FIG. 1D shows a situation in which the largest second radius R2 is identical for the second coupling elements 421A and 421B. This situation constitutes the hand-over point where the second coupling element 421A just starts to transmit torque and the second coupling element 421B just stops transmitting torque.

It will be appreciated that the transmission ratio from the first drive element 410 to the second drive element 420 depends on the ratio of the radii R1 and R2. For each first coupling element 411 the second radius R2 from the second axis 406 will slightly decrease and increase again between the hand-over points (411A, 411B). Therefore, the transmission ratio will also slightly increase and decrease. Similarly, the transmission ratio from the second drive element to the third drive element depends on the ratio of the radii R1 and R2. For each second coupling element 421 the second radius R2 from the second axis 406 will slightly decrease and increase again between the hand-over points (421A, 421B). In order to minimize this effect, the first radial guides 413 may be positioned angularly offset relative to the second radial guides 423. The first radial guides 413 may e.g. be angularly positioned halfway between two second radial guides 423. This can e.g. be seen in FIG. 2.

A continuously variable first transmission ratio can be obtained between the first drive element 410, which may be an input of the CVT unit 403, and the second drive element 420. A continuously variable second transmission ratio can obtained between the second drive element 420 and the third drive element 430, which may be an output of the CVT unit 403. A continuously variable transmission ratio of the CVT unit 403 between the first drive element 410 and the third drive element 430 can be accordingly be obtained, being a product of the first and the second transmission ratios. Hence, a resulting range of transmission ratios of the CVT unit 403 including the first, second and third drive element is larger than a range of the first or second transmission ratios. The first and second transmission ratios may particularly be equal.

In this particular example, the CVT unit 403 has five first coupling elements 411 and five second coupling elements 421, associated respectively with five first radial guides 413 and five second radial guides 423. Here, all of the first coupling elements 411, 421 are the same. The orientation of the first and second coupling elements is, however, opposite. This is because the first coupling elements 411 are to transmit torque when driven by the first drive element 410, and the second coupling elements 421 are to transmit torque when driving the third drive element 430. The first radial guides 413, and similarly the second radial guides 423, are evenly and angularly spaced from one another. Here, the first radial guides 413 are in antiphase with respect to the second radial guides 423. In this particular example, the first radial guides 413 are angularly shifted about the second axis 406 with respect to the second radial guides 423 by 36 degrees.

The CVT unit 403 is programmable to be operable according to any transmission ratio within a CVT transmission ratio range. In this example, the CVT unit 403 is operable according any transmission ratio within a range of 1 to about 1.5, e.g. 1 to 1.5. However, other ranges are conceivable e.g. 1 to 2. The CVT unit 403 can be controlled to selectively operate at one of two, three, four, five, or more distinct transmission ratios within the range.

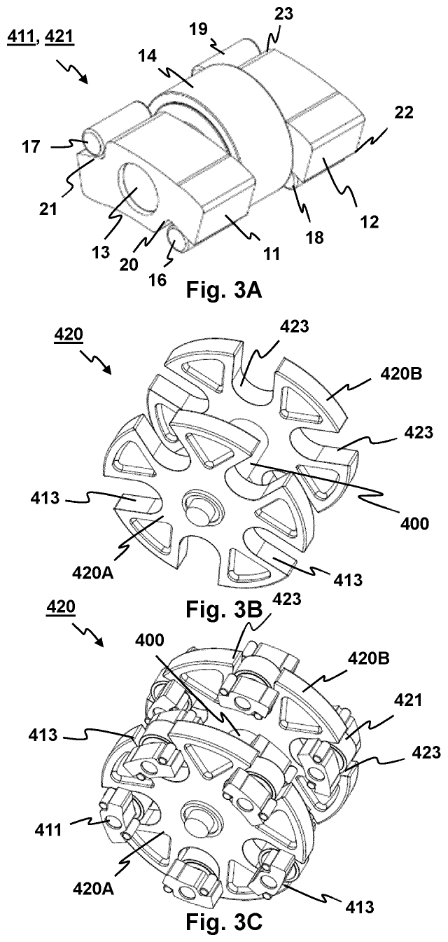

FIG. 3A shows an example of coupling element 411, 421 of the first and second coupling elements 411, 421. The coupling element 411, 421 is arranged to be allowed to move relative to the first or second concentric guide 412, 422 in a freewheel direction, and to be coupled to the first or second concentric guide 412, 422 when driven in opposite direction. In the example, the coupling element 411, 421 comprise a wedging body, in this case two wedging bodies 11, 12, tiltable about a tilt axis, here formed by pen 13, between a neutral position in which free movement of the coupling element 411, 421 relative to the first or second concentric guide 412, 422 is allowed, and a wedged position in which the wedging bodies 11, 12 are wedged between two concentric races of the first or second concentric guide 412, 422 for coupling the coupling element 411, 421 to the first or second concentric guide 412, 422. Each wedging body 11, 12 is associated with at least one roller, in this example two rollers 16, 17, 18, 19 for activating the tilting of the wedging body 11, 12 from the neutral position to the wedged position. Each wedging body 11, 12 comprises a converging wedging recess 20, 22 for receiving a first one of the rollers 16, 18 and a diverging wedging recess 21, 23 for receiving a second one of other rollers 17, 19. Here converging and diverging are defined as seen in a direction away from the axis 13 of the wedging body. With respect to the freewheel direction of the coupling element 411, 421, the converging wedging recess 20, 22 is arranged at a leading side of each wedging body 11, 12 and the diverging wedging recess 21, 23 is arranged at a trailing side of the wedging body 11, 12. Here, the converging wedging recess 20, 22 is arranged for running along an inner race of the first or second concentric guide 412, 422, and the diverging wedging edge 21, 23 is arranged for running along an outer race of the first or second concentric guide 412, 422.

The wedging recesses 20-23 are configured to cooperate with their respective rollers 16-19 such that each wedging body 11, 12 is tilted from the neutral position to the wedged position when the coupling element 411, 421 is driven in a direction opposite the freewheel direction.

FIG. 3B shows an example of the second drive element 420, which, here, comprises a first body 420A and a second body 420B which are rigidly coupled to each other by means of a connecting shaft 400.

FIG. 3C shows an assembly wherein a coupling element 411, 421 as shown in FIG. 3A is provided in each of the radial guides 413, 423 of the second drive element 420 as shown in FIG. 3B.

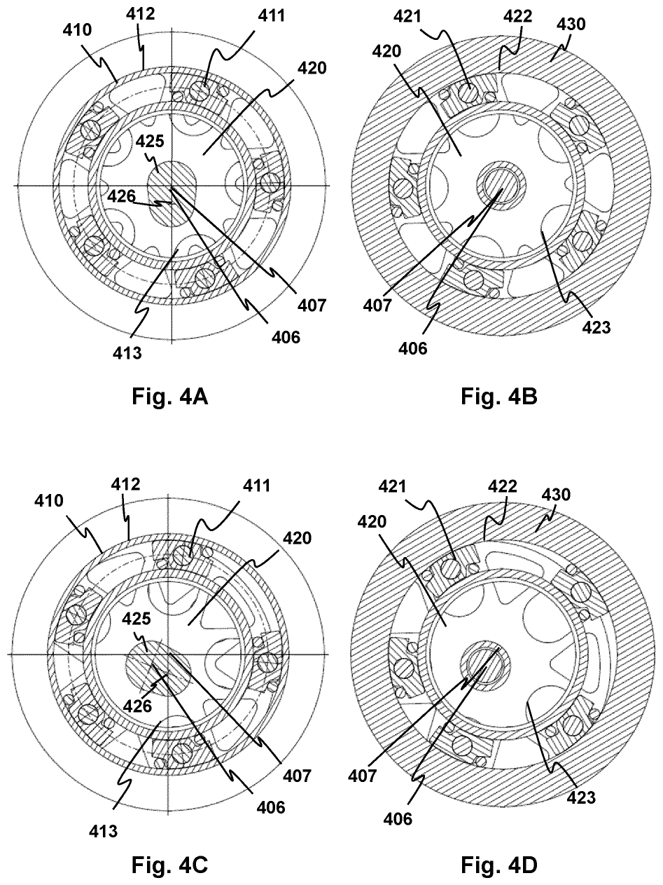

FIGS. 4A-4D show cross sectional views of an example of the CVT unit 403. FIGS. 4A and 4B show a first state of the CVT unit 403 in which the first axis 407 and the second axis 406 coincide. FIGS. 4C and 4D show a second state of the CVT unit 403 in which the second axis 406 is offset from the first axis 407. The CVT unit 403 is movable between, at least, the first and second state. FIGS. 4A and 4C particularly show a relative positioning between the first drive element 410 and the second drive element 420, and FIGS. 4B and 4D show a relative positioning between the second drive element 420 and the third drive element 430. Here the second axis 406 is carried by an axis carrier 425. The axis carrier 425 is pivotable about a pivot axis 426. An actuator may be provided for pivoting the axis carrier for adjusting an offset distance between the first axis 407 and the second axis 406. Alternatively, or additionally, a linear guide may be provided for carrying the second axis 406. An actuator may be provided for moving the linear guide for adjusting an offset distance between the first axis 407 and the second axis 406.

In the first state, the CVT unit 403 operates according to a first transmission ratio, here a 1:1 ratio, and in the second state, the CVT unit 403 for example operates according to the second transmission ratio different from the first transmission ratio. It will be appreciated that the CVT unit 403 may include additional states, for operating the CVT unit 403 according to additional transmission ratios, e.g. a third and fourth transmission ratio etc.

In the first state of the CVT unit 403, torque is transmitted from the first drive element 410 at a constant first radius from the first axis 407 to the second drive element 420 at a variable second radius from the second axis 406, wherein the first radius and the second radius are equal. In that case all first coupling elements 411 can transmit torque. Torque is also transmitted from the second drive element 420 at a constant third radius from the first axis 407 to the third drive element 430 at a variable fourth radius from the second axis 406, wherein the third radius and the fourth radius are equal. In that case all second coupling elements 421 can transmit torque. In the second state of the CVT unit 403, where the first axis 407 and the second axis 406 are eccentrically positioned relative to each other, torque is transmitted from the first drive element 410 at the constant first radius from the first axis 407 to the second drive element 420 at the variable second radius from the second axis 406, wherein the first radius and the second radius are different. Torque is also transmitted from the second drive element 420 at the constant third radius from the first axis 407 to the third drive element 430 at the variable fourth radius from the second axis 406, wherein the third radius and the fourth radius are different. In this particular example, the first and third radii are the same, and the second and fourth radii are the same.

The CVT unit 403 is operable within a range of transmission ratios, for example from a 1:1 transmission ratio to a 1:1.5 transmission ratio, wherein each transmission ratio with this range can be selected. To increase the range of transmissions for a vehicle, such as for a bicycle, the CVT unit 403 can be used in conjunction with a further transmission. The CVT unit 304 may particularly be connected in series to a further transmission. The further transmission may for example be operable according to a finite set of transmission ratios, wherein the steps between the transmission ratios of the further transmission are relatively large. The CVT unit 304 may accordingly provide intermediate transmission ratios between the large ratio steps of the further transmission.

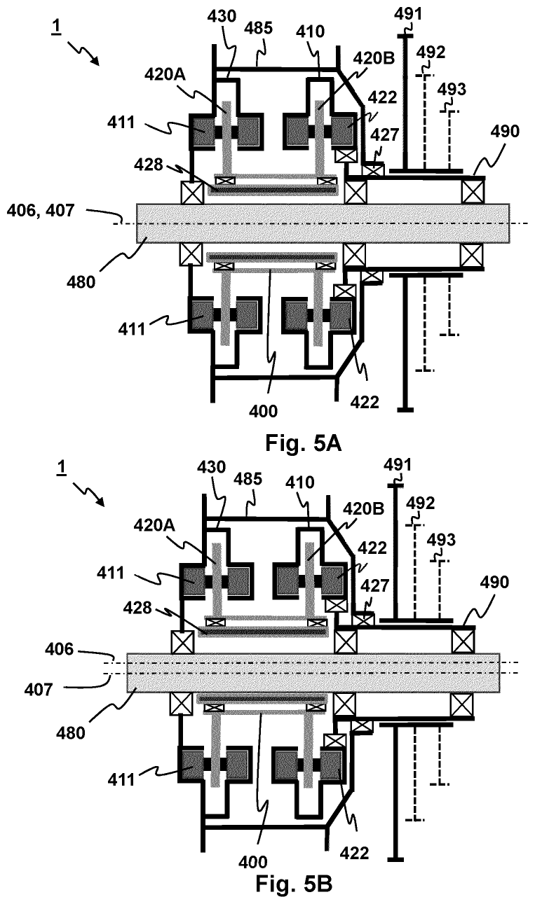

FIGS. 5A and 5B show an example of a transmission system in which the CVT unit 304 is connected in series with a further transmission which is operable according to at least two further transmission ratios. FIGS. 5A and 5B particularly show a schematic layout of a hub assembly 1, comprising a CVT unit 304. In this example, the CVT unit 304 is coaxially arranged with respect to a wheel axle 480, particularly a rear wheel axle of a bicycle. The hub assembly 1 comprises a hub shell 485, in which the CVT unit 304 is provided. The hub shell 485 is connected to an output, here a driven (rear) wheel of a bicycle. The hub assembly also comprises a driver 490, for receiving one or more sprockets such as a cassette including more than one sprocket, in this example three sprockets 491, 492, 493 of different sizes. The sprockets 491, 492, 493 are rotatably fixed to the driver 490 and are arranged to be driven by a chain or belt. The driver 490 is couplable to an input of the CVT unit 403, e.g. via a one way bearing 427, for transmitting torque. The driver 490 is particularly couplable to the first drive element 410 of the CVT unit 403.

The first drive element 410 of the CVT unit 403 is rotatable about the axle 480, wherein the first axis 407 coincides with a centerline of the axle 480. The second drive element 420 is rotatable about a bush 428. The second axis 406 coincides with a centerline of the bush 428. The bush 428 is movable in a transverse direction, transverse to the first axis 407, for changing a transmission ratio of the CVT unit 304. The third drive element 430, here, forms an output of the CVT unit 403, and is in this example fixed to the hub shell 485.

FIG. 5A shows the hub assembly 1, wherein the CVT unit 403 is in a first state in which the first and second axes 407, 406 coincide. Hence in this first state, the CVT unit 403 operates according to 1:1 transmission ratio. FIG. 5B shows the hub assembly 1, wherein the CVT unit 403 is in a second state in which the second axis 406 is offset from the first axis 407. Hence in this second state, the CVT unit 403 operates according to a transmission ratio other than a 1:1 transmission ratio, for instance a 1:1.5 transmission ratio. Regardless of the state of the CVT unit 403, any one of the sprockets 491, 492, 493 may be selected. The sprockets 491, 492, 493 can particularly be used to increase the range of available transmission ratios. Hence, a size difference between consecutive sprockets, and hence a transmission ratio step between the sprockets, may accordingly be relative large compared to conventional sprocket transmissions.

The CVT unit 403 and the further transmission, here comprising the sprockets 491, 492, 493, may be independently operated, e.g. by dedicated actuators. In this example, the chain may be shifted from one sprocket to the next, e.g. using a conventional derailleur, independently of the lateral shifting of the second drive element 420 of the CVT unit 403.

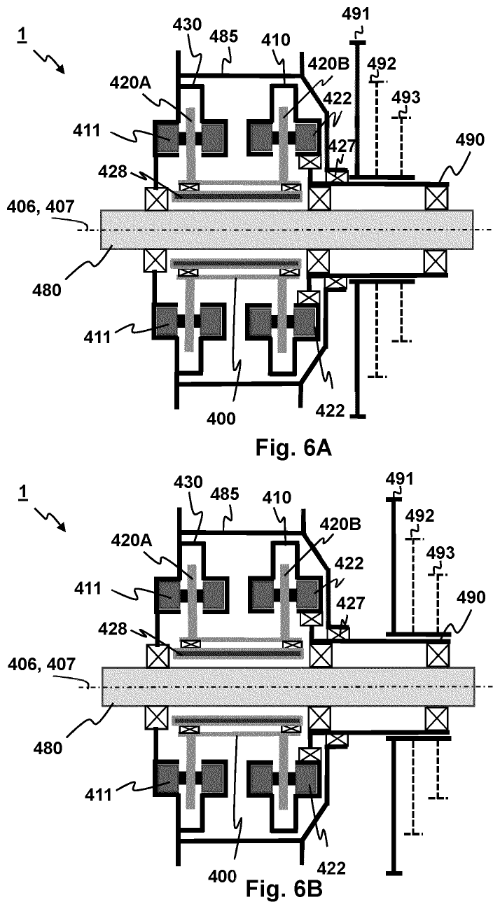

FIGS. 6A and 6B show a particular example of the hub assembly of FIGS. 5A and 5B, wherein the sprockets 491, 492, 493, are arranged to axially move relative to the driver 490 for shifting the chain from one sprocket to the next. This way, the chain can be kept straight at all times for increased efficiency.

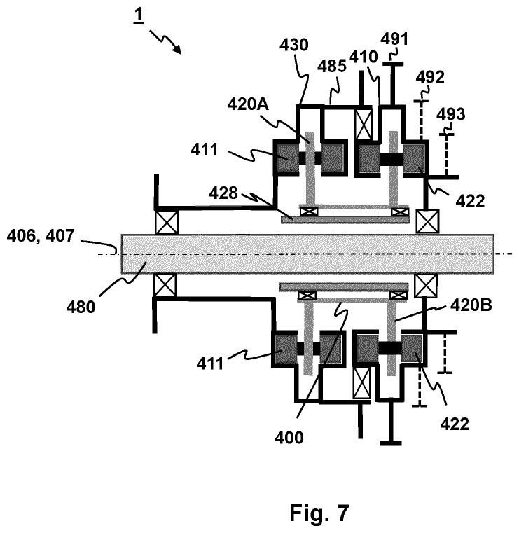

FIG. 7 shows an example of a hub assembly 1, wherein the sprockets 491, 492, 493 are fixedly mounted to an input of the CVT unit 403, here the first drive element 410. A conventional derailleur can for instance be used to shift the chain between the sprockets.

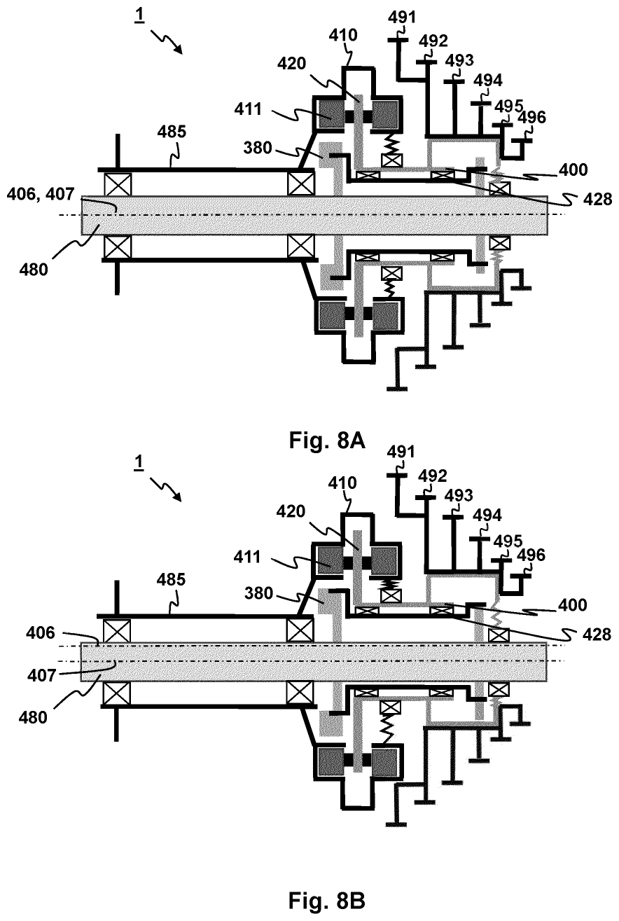

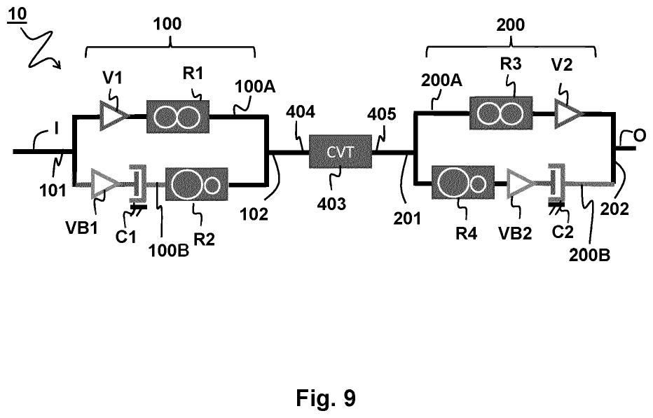

FIGS. 8A and 8B show an example of a hub assembly 1, wherein a cassette of sprockets, here having six sprockets 491, 492, 493, 494, 495, 496, is fixedly mounted to the second drive element 420. The second drive element 420 hence forms the input of the CVT unit 403 in this example. The sprockets 491-496 and the second drive element 420 are together rotatable about the second axis 406. The CVT unit 403 does, in this example, not include a third drive element 430. The first drive element 410 forms the output of the CVT unit 403, and is fixed to the hub shell 485. The first drive element 410 and the hub shell 485 are together rotatable about the first axis 407. Torque is transmitted from any of the sprockets 491-496 to the hub shell 485, via the CVT unit 403. In the example shown in FIGS. 8A, 8B, the CVT transmission ratio can be changed by moving the second drive element 420 relative to the first drive element 410 in a direction transverse to the first axis 407, here by means of an actuator 380. Hence, the cassette of sprockets 491-496 can be moved, together with the second drive element 420, eccentrically with respect to the first axis 407 to a position in which the first and second axes 407, 406 are offset from each other. FIG. 8A shows the hub assembly 1 in a centric state in which the first axis 407 and the second axis 406 coincide, and FIG. 8B shows the hub assembly 1 in an eccentric state in which the first axis 407 and the second axis 406 are offset from each other. The actuator 380 can move the hub assembly between the centric and the eccentric state.

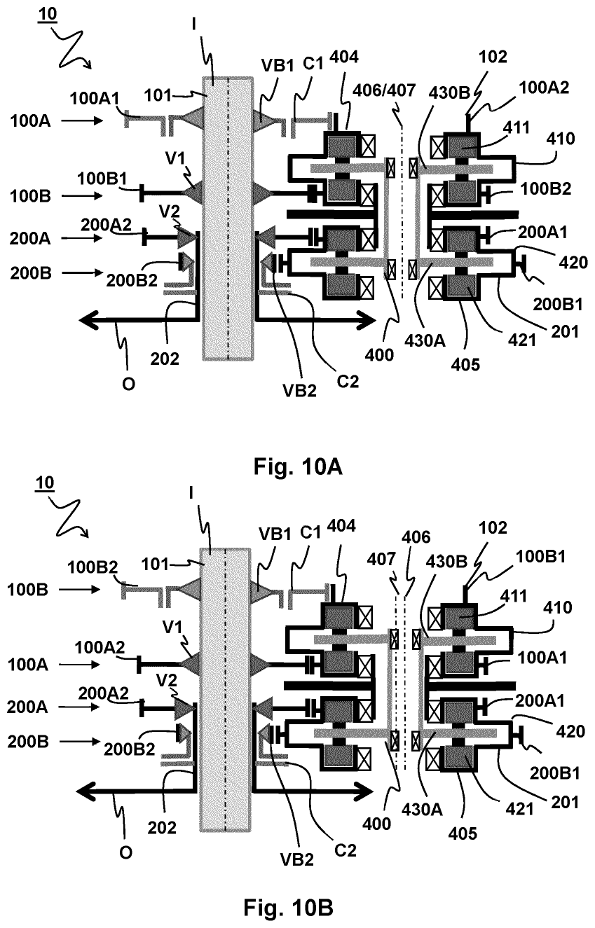

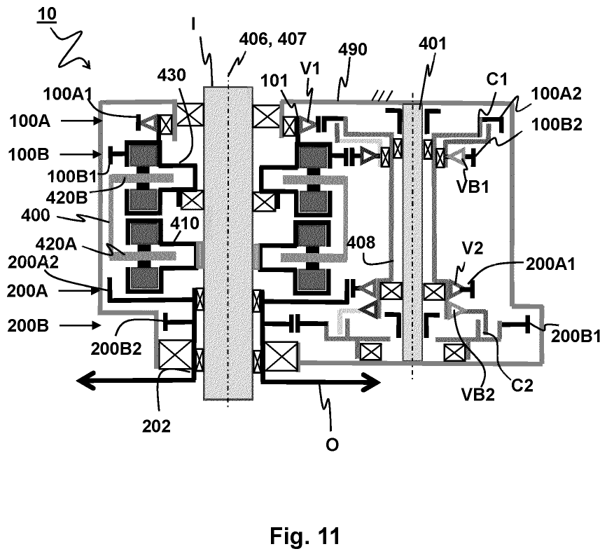

FIG. 9 shows a schematic example of a transmission system 10, comprising a CVT unit 403, a first transmission 100 and a second transmission 200. The first transmission 100 and the second transmission 200 are connected in series, wherein the CVT unit 403 is, here, connected between the first transmission 100 and the second transmission 200. FIGS. 10A and 10B show a schematic layout of the transmission system 10, as shown in FIG. 9.

The transmission system 10 includes an input I and an output O. The input I can for example be connected to a crank of the bicycle. The output O can for example be connected to a front chain ring of the bicycle. Between the input I and the output O, the system includes the first transmission 100, having two parallel transmission paths 100A, 100B, the CVT unit 403, and the second transmission 200 having two parallel second transmission paths 200A, 200B. A first input 101 of the first transmission 100 is connected to the system input I. A second output 202 of the second transmission 200 is connected to the system output O. A first output 102 of the first transmission 100 is connected to an input 404 of the CVT unit 403. An output 405 of the CVT unit 403 is connected to the second input 201 of the second transmission 200. The input shaft I and the output shaft O are in this example coaxially arranged with respect to one another, but it will be appreciated that an offset arrangement, in which the input shaft and the output shaft are offset with respect to one another, can also be provided. It will further be appreciated that the CVT unit 403 and/or the input I and/or the output O can be coaxially arranged. Here the CVT unit 403, being associated with a second axis 406, is provided offset from the input and output shafts, to obtain a particular compact setup.

Here, the first transmission 100 is operable according to a first transmission ratio and a second transmission ratio. Similarly, the second transmission 200 is operable according to a third transmission ratio and a fourth transmission ratio. The first and second transmissions 100, 200 may include respective gears 100A1, 100A2, 100B1, 100B2, 200A1, 200A2, 200B1, 200B2, for providing a reduction or increase transmission ratio between the first input 101 and first output 102, and between the second input 201 and second output 202, respectively.

The first transmission output 102 and the CVT input 404 are, here, rigidly connected to one another. Similarly, the CVT output 405 and the second transmission input 201 are also rigidly connected to one another. Here, the gears 100A2 and 100B2 of respectively the first and the second transmission paths 100A, 100B, are integrated with the CVT input 404. The gears 200A1 and 200B1 of respectively the third and the fourth transmission paths 200A, 200B are integrated with the CVT output 405. The CVT unit 403 is arranged to provide a continuously variable transmission ratio between the CVT input 404 and the CVT output 405.

To shift between the first transmission ratio and the second transmission ratio, the first transmission 100 includes a first clutch, in this example a load-shifting clutch, C1. Similarly, the second transmission 200 includes a second clutch, in this example a load-shifting clutch, C2, for selectively shifting between the third transmission ratio and the fourth transmission ratio of the second transmission 200.

The first transmission 100 has two parallel transmission paths between the first input 101 and first output 102, namely a first transmission path 100A and a second transmission path 100B. At least one of the first and second transmission paths 100A, 100B includes the first load-shifting clutch C1. Also, at least one of the parallel transmission paths 100A, 100B includes a transmission gearing. In this example, the first transmission path 100A includes a gears 100A1, 100A2 arranged for providing the first transmission ratio, and the second transmission path 100B includes a gears 100B1, 100B2 for providing the second transmission ratio.

Similarly, the second transmission 200 has two parallel transmission paths between the second input 201 and the second output 202, namely a third transmission path 200A and a fourth transmission path 200B. at least one of the third and fourth transmission paths 200A, 200B includes the second load-shifting clutch C2. Also, at least one of the parallel transmission paths 200A, 200B of the second transmission 200 includes a transmission gearing. In this example, the third transmission path 200A includes gears 200A1, 200A2 arranged for providing the third transmission ratio, and the fourth transmission path 200B includes a gears 200B1, 200B2 for providing the fourth transmission ratio.

The load-shifting clutches C1 and C2, can be used to select an appropriate transmission path between the system input I and system output O. More particular, the first load-shifting clutch C1 can be used to selectively switch between the first 100A and second 100B parallel transmission paths of the first transmission 100, and the second load-shifting clutch C2 can be used to selectively switch between the third 200A and fourth 200B parallel transmission paths of the second transmission 200.

The load-shifting clutches include at least two states, e.g. a coupled state and a decoupled state, wherein the coupled state couples the clutch input with the clutch output to transmit torque through the clutch, and the decoupled state decouples the clutch input from the clutch output to transmit no torque through the clutch. In the decoupled state, the load shifting clutches C1, C2 enable torque to be transmitted through different, parallel, transmission path.

In the coupled state of the first load-shifting clutch C1, torque can be transmitted through the second transmission path 100B from the system input I to the first output 102. In the decoupled state, torque can be transmitted through the first transmission path 100A from the system input I to the first output 102. Similarly, in the coupled state of the second load-shifting clutch C2, torque can be transmitted through the fourth transmission path 200B from the second input 201 to the system output O. In the decoupled state, torque can be transmitted through the third transmission path 200A from the first input 201 to the system output O.

In this example, the load-shifting clutches C1, C2 are provided in, respectively, the first transmission path 100A and the fourth transmission path 200B, but it will be appreciated that the first load-shifting clutches C1, C2 can also be provided in, respectively, the second transmission path 100B and the third transmission path 200A.

Here, the first transmission path 100A includes a first freewheel clutch V1. The first freewheel clutch V1 can be overrun, e.g. when torque is transmitted through the first transmission path 100A, e.g. when the first output 102 rotates faster than the first input 101. Here, the third transmission path 200A includes a second freewheel clutch V2. The second freewheel clutch V2 can be overrun, e.g. when torque is transmitted through the fourth transmission path 200B, e.g. when the second output 202 rotates faster than the second input 201. The freewheel clutches V1, V2 are preferably low friction when overrun to reduce losses.

The load-shifting clutches C1, C2 are, at least in this example, particularly arranged to be coupled and decoupled under load, i.e. while torque is transferred through the load-shifting clutch. The load-shifting clutches C1, C2 are for instance form-closed clutches. It will be appreciated that any of the load-shifting clutches may also be force-closed clutches, arranged to transfer torque in at least one rotational direction.

It is preferred that clutches C1 and C2 are load-shifting clutches, arranged to be coupled and/or decoupled under load, however, it will be appreciated clutches C1 and C2 need not be load-shifting clutches. An example of load-shifting clutches is described in WO2018/199757A2, WO2020/085911A2, or WO2021/080431A1.

Here, the first transmission 100 and the second transmission 200 each comprise a further clutch. In this example, the first transmission 100 comprises a first further freewheel clutch VB1, and the second transmission 200 comprises a second further freewheel clutch VB2. The further freewheel clutches VB1, VB2 are, here, connected to the respective inputs of the load-shifting clutches C1, C2, but it will be appreciated that the further freewheel clutches VB1 and VB2 can also be connected to the respective outputs of the load-shifting clutches C1, C2. It may be preferred to connect the further freewheel clutches VB1, VB2 to the respective inputs of the load-shifting clutches C1, C2, so that the outputs of the load shifting clutches C1, C2 can keep rotating even without inputting any torque their the inputs. This may facilitate coupling and/or decoupling of the load-shifting clutches C1, C2. The further clutches VB1 and VB2 can be particularly arranged to allow for a reverse rotation direction of the output O, i.e. opposite a driving rotation direction, relative to the input I.

In this example, the output 102 of the first transmission 100 is connected to an input 404 of the CVT unit 403. An output 405 of the CVT unit 403 is connected to the input 201 of the second transmission 200. The CVT unit 403 is arranged to provide a transmission ratio between the CVT input 404 and the CVT output 405. The input 404 and output 405 of the CVT are rotatable relative to one another, wherein the CVT unit 403 can for example be operable according to at least a fifth transmission ratio and a sixth transmission ratio, and additionally a seventh transmission ratio etc. between the input 404 and output 405. In this example, the CVT unit 403 is similar to that as shown in FIGS. 1-8.

The CVT unit 403 is here associated with an intermediate axis of the transmission system 10. The intermediate axis being here defined by the first axis 407 of the CVT unit 403 which extends parallel to the input axis of the transmission system 10.

FIG. 10A shows a first state of the CVT unit 403 in which the second axis 406 and the first axis 407 coincide. FIG. 10B shows a second state of the CVT unit 403 in which the second axis 406 is offset from the first axis 407. The CVT unit 403 is movable between, at least, the first and second state. In the first state, the CVT unit 403 for example operates according to the seventh transmission ratio, here a 1:1 ratio, and in the second state, the CVT unit 403 for example operates according to the eighth transmission ratio, here a 1:1.5 ratio. It will be appreciated that the CVT unit 403 may include additional states, for operating the CVT unit 403 according to additional transmission ratios, e.g. a ninth transmission ratio.

The transmission system 10 is operable according to various transmission ratios, wherein the CVT unit 403 provides for (pre)programmable transmission ratios. For example, table 1 shows an example of system transmission ratios that are obtainable by the transmission system 10 as shown in FIGS. 10A, 10B. The example of table 1 shows a seven-speed transmission system 10 with a substantially constant transmission step size of about 1.25.

TABLE 1

| | C1 | C2 | RCVT | System transmission ratio |
|---|---|---|---|---|
| R1 = 0.90 | Decoupled | Decoupled | 1.00 | 0.8 (R1*R3*RCVT) |
| R2 = 1.28 | Decoupled | Decoupled | 1.25 | 1 (R1*R3*RCVT) |
| R3 = 0.89 | Coupled | Decoupled | 1.10 | 1.25 (R2*R3*RCVT) |
| R4 = 1.79 | Coupled | Decoupled | 1.37 | 1.56 (R2*R3*RCVT) |
| | Decoupled | Coupled | 1.21 | 1.95 (R1*R4*RCVT) |
| | Coupled | Coupled | 1.07 | 2.45 (R2*R4*RCVT) |
| | Coupled | Coupled | 1.33 | 3.05 (R2*R4*RCVT) |

In the example of table 1, each consecutive shift changes the system transmission ratio with, approximately, 25%. The transmission ratios of the CVT unit 403, RCVT, can be preprogrammed. The CVT can accordingly by controlled to switch from one preprogrammed transmission ratio to another.

Table 2 shows another example of system transmission ratios that are obtainable by a transmission system 10 as shown in FIGS. 10A,10B. This example shows a 10-speed transmission system 1, with a constant transmission step size of about 1.17. The CVT can accordingly by controlled to switch from one preprogrammed transmission ratio to another.

TABLE 2

| | C1 | C2 | RCVT | System transmission ratio |
|---|---|---|---|---|
| R1 = 0.90 | Decoupled | Decoupled | 1.00 | 0.80 (R1*R3*RCVT) |
| R2 = 1.28 | Decoupled | Decoupled | 1.17 | 0.94 (R1*R3*RCVT) |
| R3 = 0.89 | Decoupled | Decoupled | 1.38 | 1.10 (R1*R3*RCVT) |
| R4 = 1.79 | Coupled | Decoupled | 1.12 | 1.28 (R2*R3*RCVT) |
| | Coupled | Decoupled | 1.32 | 1.50 (R2*R3*RCVT) |
| | Decoupled | Coupled | 1.09 | 1.75 (R1*R4*RCVT) |
| | Decoupled | Coupled | 1.27 | 2.05 (R1*R4*RCVT) |
| | Coupled | Coupled | 1.05 | 2.40 (R2*R4*RCVT) |
| | Coupled | Coupled | 1.23 | 2.81 (R2*R4*RCVT) |
| | Coupled | Coupled | 1.43 | 3.29 (R2*R4*RCVT) |

In the example of table 2, each consecutive shift changes the system transmission ratio with, approximately, 17%. The transmission ratios of the CVT unit 403 (RCVT) can be preprogrammed.

Table 3 shows another example of system transmission ratios that are obtainable by a transmission system 10 as shown in FIGS. 10A,10B. This example shows a 16-speed transmission system 1, with a constant transmission step size of about 1.10.

TABLE 3

| | C1 | C2 | RCVT | System transmission ratio |
|---|---|---|---|---|
| R1 = 0.90 | Decoupled | Decoupled | 1.00 | 0.80 (R1*R3*RCVT) |
| R2 = 1.28 | Decoupled | Decoupled | 1.10 | 0.88 (R1*R3*RCVT) |
| R3 = 0.89 | Decoupled | Decoupled | 1.21 | 0.97 (R1*R3*RCVT) |
| R4 = 1.79 | Decoupled | Decoupled | 1.32 | 1.06 (R2*R3*RCVT) |
| | Coupled | Decoupled | 1.03 | 1.17 (R2*R3*RCVT) |
| | Coupled | Decoupled | 1.13 | 1.29 (R1*R4*RCVT) |
| | Coupled | Decoupled | 1.25 | 1.42 (R1*R4*RCVT) |
| | Coupled | Decoupled | 1.37 | 1.56 (R2*R4*RCVT) |
| | Decoupled | Coupled | 1.06 | 1.71 (R2*R4*RCVT) |
| | Decoupled | Coupled | 1.16 | 1.87 (R2*R3*RCVT) |
| | Decoupled | Coupled | 1.29 | 2.07 (R1*R4*RCVT) |
| | Decoupled | Coupled | 1.42 | 2.28 (R1*R4*RCVT) |
| | Coupled | Coupled | 1.09 | 2.51 (R2*R4*RCVT) |
| | Coupled | Coupled | 1.20 | 2.76 (R2*R4*RCVT) |
| | Coupled | Coupled | 1.33 | 3.04 (R2*R4*RCVT) |
| | Coupled | Coupled | 1.45 | 3.34 (R2*R4*RCVT) |

In the example of table 3, each consecutive shift changes the system transmission ratio with, approximately, 10%. The transmission ratios of the CVT unit 403 (RCVT) can be preprogrammed. The CVT can accordingly by controlled to switch from one preprogrammed transmission ratio to another.

Table 4 shows another example of system transmission ratios that are obtainable by a transmission system 10 as shown in FIGS. 10A,10B. This example shows a 16-speed transmission system 1, with a constant transmission step size of about 1.12.

TABLE 4

| | C1 | C2 | RCVT | System transmission ratio |
|---|---|---|---|---|
| R1 = 1.11 | Decoupled | Decoupled | 1.00 | 0.60 (R1*R3*RCVT) |
| R2 = 1.73 | Decoupled | Decoupled | 1.12 | 0.67 (R1*R3*RCVT) |
| R3 = 0.55 | Decoupled | Decoupled | 1.25 | 0.75 (R1*R3*RCVT) |
| R4 = 1.35 | Decoupled | Decoupled | 1.40 | 0.84 (R1*R3*RCVT) |
| | Coupled | Decoupled | 1.00 | 0.94 (R2*R3*RCVT) |
| | Coupled | Decoupled | 1.12 | 1.06 (R2*R3*RCVT) |
| | Coupled | Decoupled | 1.25 | 1.18 (R2*R3*RCVT) |
| | Coupled | Decoupled | 1.40 | 1.33 (R2*R3*RCVT) |
| | Decoupled | Coupled | 1.00 | 1.49 (R1*R4*RCVT) |
| | Decoupled | Coupled | 1.12 | 1.66 (R1*R4*RCVT) |
| | Decoupled | Coupled | 1.25 | 1.86 (R1*R4*RCVT) |
| | Decoupled | Coupled | 1.40 | 2.09 (R1*R4*RCVT) |
| | Coupled | Coupled | 1.00 | 2.34 (R2*R4*RCVT) |
| | Coupled | Coupled | 1.12 | 2.62 (R2*R4*RCVT) |
| | Coupled | Coupled | 1.25 | 3.93 (R2*R4*RCVT) |
| | Coupled | Coupled | 1.40 | 3.28 (R2*R4*RCVT) |

Table 5 shows another example of system transmission ratios obtainable by a transmission system as shown in FIGS. 10A, 10B. This example shows a 21-speed transmission system 1, with a constant transmission step size of about 1.07.

TABLE 5

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.07 | 0.76 (R1*R3*RCVT) |
| R3 = 1.00 | Decoupled | Decoupled | 1.15 | 0.82 (R1*R3*RCVT) |
| R4 = 2.00 | Decoupled | Decoupled | 1.23 | 0.87 (R1*R3*RCVT) |
| | Decoupled | Decoupled | 1.32 | 0.94 (R1*R3*RCVT) |
| | Coupled | Decoupled | 1.00 | 1.00 (R2*R3*RCVT) |
| | Coupled | Decoupled | 1.07 | 1.07 (R2*R3*RCVT) |
| | Coupled | Decoupled | 1.15 | 1.15 (R2*R3*RCVT) |
| | Coupled | Decoupled | 1.23 | 1.23 (R2*R3*RCVT) |
| | Coupled | Decoupled | 1.32 | 1.32 (R2*R3*RCVT) |
| | Decoupled | Coupled | 1.00 | 1.42 (R1*R4*RCVT) |
| | Decoupled | Coupled | 1.07 | 1.52 (R1*R4*RCVT) |
| | Decoupled | Coupled | 1.15 | 1.63 (R1*R4*RCVT) |
| | Decoupled | Coupled | 1.23 | 1.75 (R1*R4*RCVT) |
| | Decoupled | Coupled | 1.32 | 1.88 (R1*R4*RCVT) |
| | Coupled | Coupled | 1.00 | 2.00 (R2*R4*RCVT) |
| | Coupled | Coupled | 1.07 | 2.14 (R2*R4*RCVT) |
| | Coupled | Coupled | 1.15 | 2.30 (R2*R4*RCVT) |
| | Coupled | Coupled | 1.23 | 2.46 (R2*R4*RCVT) |
| | Coupled | Coupled | 1.32 | 2.64 (R2*R4*RCVT) |
| | Coupled | Coupled | 1.42 | 2.83 (R2*R4*RCVT) |

Tables 6-8 provide further examples of a set of system transmission ratios obtainable by a transmission system as shown in FIG. 10A, 10B. The transmission ratios R1, R2, R3, R4 are the same as for the example of table 5, however, compared to table 5, instead of a 21-speed transmission system, tables 6-8 show respectively a 17-speed, 13-speed and 9-speed transmission system. The overall range of system transmission ratios are substantially the same between the examples, as provided by R1-R4, here about 400% o, but compared to table 5, the CVTs provide less intermediate steps.

TABLE 6

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.09 | 0.77 (R1*R3*RCVT) |
| R3 = 1.00 | Decoupled | Decoupled | 1.19 | 0.84 (R1*R3*RCVT) |
| R4 = 2.00 | Decoupled | Decoupled | 1.30 | 0.92 (R1*R3*RCVT) |
| | Coupled | Decoupled | 1.00 | 1.00 (R2*R3*RCVT) |
| | Coupled | Decoupled | 1.09 | 1.09 (R2*R3*RCVT) |
| | Coupled | Decoupled | 1.19 | 1.19 (R2*R3*RCVT) |
| | Coupled | Decoupled | 1.30 | 1.30 (R2*R3*RCVT) |
| | Decoupled | Coupled | 1.00 | 1.41 (R1*R4*RCVT) |
| | Decoupled | Coupled | 1.09 | 1.54 (R1*R4*RCVT) |
| | Decoupled | Coupled | 1.19 | 1.68 (R1*R4*RCVT) |
| | Decoupled | Coupled | 1.30 | 1.83 (R1*R4*RCVT) |
| | Coupled | Coupled | 1.00 | 2.00 (R2*R4*RCVT) |
| | Coupled | Coupled | 1.09 | 2.18 (R2*R4*RCVT) |
| | Coupled | Coupled | 1.19 | 2.38 (R2*R4*RCVT) |
| | Coupled | Coupled | 1.30 | 2.59 (R2*R4*RCVT) |
| | Coupled | Coupled | 1.41 | 2.82 (R2*R4*RCVT) |

TABLE 7

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.12 | 0.80 (R1*R3*RCVT) |
| R3 = 1.00 | Decoupled | Decoupled | 1.25 | 0.89 (R1*R3*RCVT) |
| R4 = 2.00 | Coupled | Decoupled | 1.00 | 1.00 (R2*R3*RCVT) |
| | Coupled | Decoupled | 1.12 | 1.12 (R2*R3*RCVT) |
| | Coupled | Decoupled | 1.25 | 1.25 (R2*R3*RCVT) |
| | Decoupled | Coupled | 1.00 | 1.42 (R1*R4*RCVT) |
| | Decoupled | Coupled | 1.12 | 1.59 (R1*R4*RCVT) |
| | Decoupled | Coupled | 1.25 | 1.78 (R1*R4*RCVT) |
| | Coupled | Coupled | 1.00 | 2.00 (R2*R4*RCVT) |
| | Coupled | Coupled | 1.12 | 2.24 (R2*R4*RCVT) |
| | Coupled | Coupled | 1.25 | 2.51 (R2*R4*RCVT) |
| | Coupled | Coupled | 1.40 | 2.81 (R2*R4*RCVT) |

TABLE 8

| | C1 | C2 | RCVT | System transmission ratio |
|---|---|---|---|---|
| R1 = 0.71 | Decoupled | Decoupled | 1.00 | 0.71 (R1*R3*RCVT) |
| R2 = 1.00 | Decoupled | Decoupled | 1.19 | 0.84 (R1*R3*RCVT) |
| R3 = 1.00 | Coupled | Decoupled | 1.00 | 1.00 (R2*R3*RCVT) |
| R4 = 2.00 | Coupled | Decoupled | 1.19 | 1.19 (R2*R3*RCVT) |
| | Decoupled | Coupled | 1.00 | 1.42 (R1*R4*RCVT) |
| | Decoupled | Coupled | 1.19 | 1.68 (R1*R4*RCVT) |
| | Coupled | Coupled | 1.00 | 2.00 (R2*R4*RCVT) |
| | Coupled | Coupled | 1.19 | 2.37 (R2*R4*RCVT) |
| | Coupled | Coupled | 1.40 | 2.81 (R2*R4*RCVT) |

The CVT unit 403 provides intermediate transmission ratio steps, between the system transmission ratios obtainable with only the first and second transmissions 100, 200. Hence, the first and second transmission 100, 200 combined can provide a spread of system transmission ratios, while the CVT unit 403 can be used to provide appropriate, intermediate, steps between consecutive system ratios. The unit CVT unit 403 can also be used to extend the range of system transmission ratios provided by the first and second transmissions 100, 200.

In these examples, the transmission ratios are particularly chosen such that the number of different CVT transmission ratios RCVT is less than the number of system transmission ratios. The number of different CVT transmission ratios RCVT is particularly less than half the number of system transmission ratios, more particularly about 25% of the number of system transmission ratios.

The examples of tables 1-8 show a relation between the system transmission ratios having a, substantially, constant transmission ratio step between consecutive system transmission ratios. It will be appreciated that any relation can also be obtained using the CVT unit 403, e.g. progressively increasing and/or decreasing transmission ratio steps between consecutive system transmission ratios. The CVT unit 403 can be operated accordingly, e.g. using a control unit. A constant step size between system transmission ratios may be regarded as a linear set of transmission ratios. It will be appreciated that nonlinear sets may also be obtained by programming the CVT transmission ratios RCVT accordingly. For example, a progressively increasing or decreasing transmission steps can be obtained. The steps may even be changed on-the-fly, i.e. during operation of the transmission, e.g. by properly selecting or re-programming of the CVT transmission ratios RCVT.

FIG. 11 shows an example of a transmission system 10, similar to the example shown in FIGS. 10A, 10B, but wherein the CVT unit 403 is arranged between the system input I and the first transmission 100. Hence, the first drive element 410 is mounted to the input shaft I, and the third drive element 430 is coupled to the input 101 of the first transmission 100. The CVT unit 403 is here associated with the input axis. The first drive element 410 and the third drive element 430 are coaxially arranged with the input axis. The intermediate axis is here defined by a stationary mounting shaft 401, which extends parallel to the input axis.

The input shaft I may for example be attached to a crank of a bicycle. Hence, the input shaft I may be a crank spindle. The transmission shown in FIG. 11 may thus, for example, be a crank transmission. The third drive element 430, forming the CVT output, is connected to the first input 101 of the first transmission 100. The CVT unit 403 is arranged to provide a continuously variable transmission ratio, e.g. a set of preprogrammed CVT transmission ratios, between the CVT input and the CVT output, formed by the third drive element 430. The third drive element 430 is connected to the first input 101 of the first transmission 100, and is hereto provided with gear 100A1 for meshing with gear 100A2 for forming the first transmission path 100A, and gear 100B1 for meshing with gear 100B2 for forming the second transmission path 100B.

The CVT unit 403 is in this example coaxially arranged with the input shaft I, i.e. the first axis 407 coincides with the drive axis of the input shaft I. Furthermore, in this example, the connecting shaft 400, which connects the first and second bodies 420A, 420B of the second drive element 420, is arranged radially outside of the first and third drive elements 410, 430. In other words, the first and third drive bodies 410, 430 are generally arranged, in radial direction with respect to the first axis 407, between the first axis 407 and the connecting shaft 400. The connecting shaft 400, may alternatively be arranged radially inside of the first and third drive elements 410, 430.

The CVT is configured to apply a CVT transmission ratio, e.g. a fifth and sixth transmission ratio between the first drive element 410, here being rotationally fixed to the input shaft I, and the third drive element 430. The first transmission 100 is formed in this example between the third driven element 430 and a lay shaft 408. The second transmission 200 is formed between the lay shaft 408 and the output shaft O. The lay shaft 408 is in this example rotatable relative to the stationary mounting shaft 401. The stationary mounting shaft 401 can for example be mounted to a housing 490 of the transmission system 10.

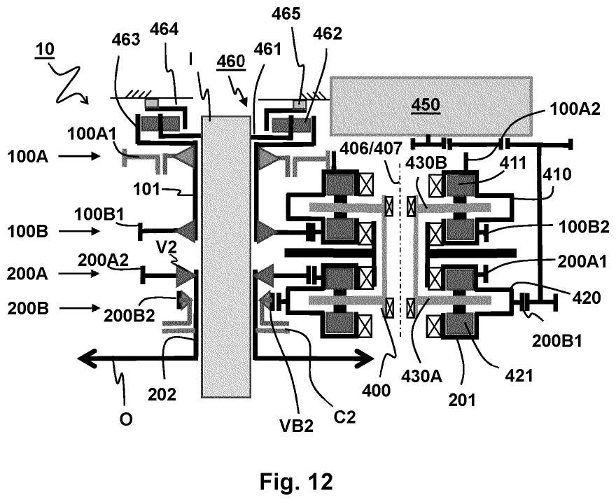

FIG. 12 shows an example of a transmission system 10, similar to the example of FIGS. 10A, 10B, wherein an electric motor 450 is connected to the third drive element 430. In this configuration, torque supplied by the electric motor 450 is not transmitted through the CVT unit 403. The electric motor 450 can be used for propelling, or at least assisting in propelling the vehicle. The second transmission 200 is arranged between the electric motor 450 and the system output O. In particular, gears 200A1, 200A2, and gears 200B1, 200B2 are arranged between the electric motor 450 and the system output O, which provide two selectable transmission ratios between the electric motor and the system output O, for example a 1:1 and a 2:1 ratio.

The transmissions system 10 in this example also comprises a speed-up gear 460 between the system input I and the input 101 of the first transmission 100. It will be appreciated that the speed-up gear 460 and the electric motor 450 are independent features. The speed-up gear 460 provides speed increase from the system input I and the first input 101. Here, the speed-up gear 460 comprises a planetary gear set comprising carrier 461 coupled to the input shaft, a planet gear 462 carried by the carrier 461 and a ring gear 463 coupled to the first input 101. The planet gear 462 meshes with the ring gear 463. A stationary sun gear 464 also meshes the planet gear 262, wherein the sun gear 464 is immobile, e.g. relative to a frame of the vehicle more specifically a frame of a bicycle. The sun gear 464, in this example, is connected to a torque sensor 465. The torque sensor 465 is arranged for measuring a torque at the system input I, e.g. a crank torque of a bicycle. Such stationary torque sensor 465 is particularly accurate compared to non-stationary torque sensors.

In particular for bicycles, but also for other vehicles, the input torque a the system input I may typically be high, at a relatively low speed. The speed-up gear 460 thus provides a speed increase as well as a torque reduction, between the system input I and the first input 101. This reduces loads on the transmission system 1, particularly on the first 100, second 200 (and any further) transmissions, as well as on the CVT unit 403.

In the examples the CVT unit 403 includes the first drive element 410, second drive element 420 and third drive element 430. An input of the CVT unit can then be associated with the first drive element 410 and an output of the CVT unit can then be associated with the third drive element 430. This provides the advantage that it is possible that the input and the output of the CVT unit are stationary, with the second axis 406 being movable. It will be appreciated that it is also possible that the input of the CVT unit is associated with the first drive element 410 and the output of the CVT unit is associated with second drive element 420. In such case, the third drive element 430 may be omitted.

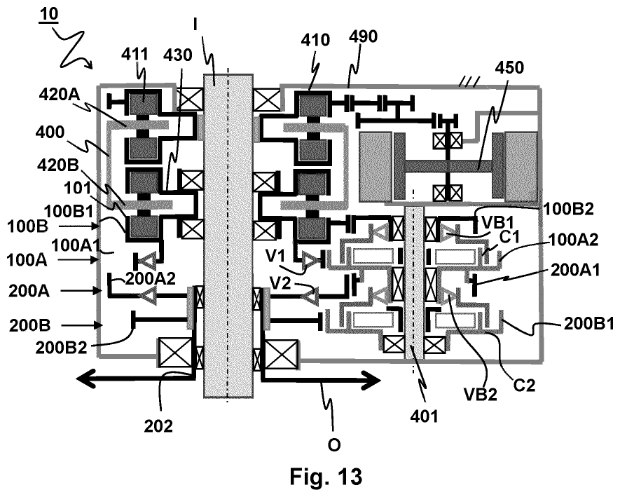

FIG. 13 shows an exemplary layout of a transmission system 10, similar to the transmission system 10 as shown in FIG. 11, wherein an electric motor 450 is provided within the housing 490. Here, the electric motor 450 is connected to the first drive element 410 of the CVT unit 403, here via a reduction gearing. The first drive element 410 is in turn coupled to the input shaft I. Hence, the electric motor 450 drives the input shaft I in rotation, via the first drive element 410. The input shaft I can additionally be driven by an additional power source, such as by muscle power of a user transmitted to the input shaft I, e.g. via a crank.

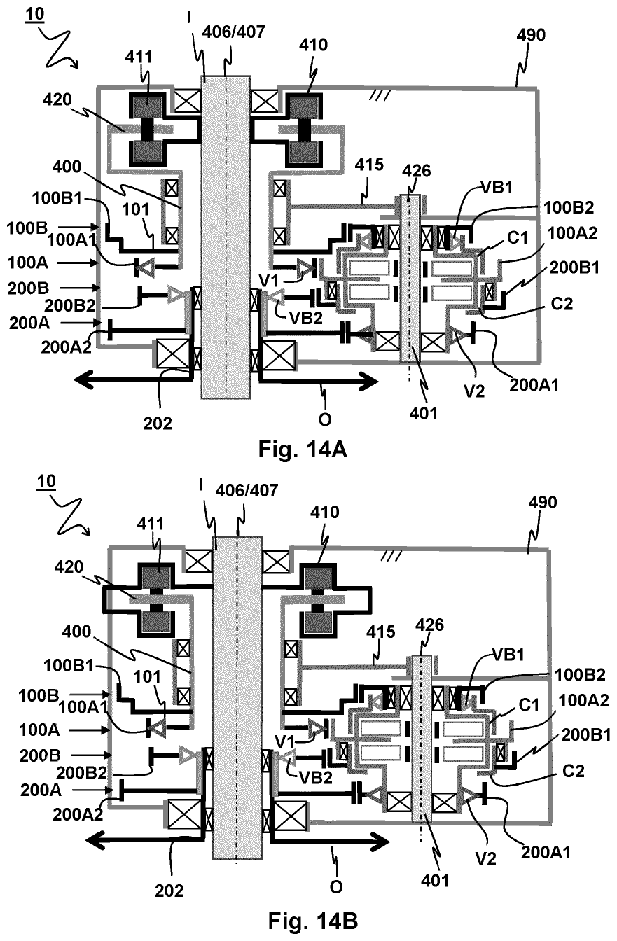

FIGS. 14A and 14B show respective examples of a transmission system 10, wherein the CVT unit 403 is arranged between the system input I and the first transmission 100. The first drive element 410 is here mounted to the input shaft I and rotates therewith, and the second drive element 420 is coupled to the input 101 of the first transmission 100. The CVT unit 403, in this example, does not comprise a third drive element 430. The first drive element 410 forms the input of the CVT unit 403, and the second drive element 420 forms the output of the CVT unit 403. Torque is transmitted from the first drive element 410 to the second drive element 420 via the first coupling elements 411. The first coupling elements 411 engage the first drive element 410 at the constant first radius from the first axis 407 and the second drive element 420 at a variable second radius from the second axis 406.

FIGS. 14A and 14B show respective configurations of the CVT unit 403. In the example of FIG. 14A, the connecting shaft 400 is arranged radially outside of the first drive element 410, and in the example of FIG. 14B, the connecting shaft 400 is arranged radially inside of the first drive element 410.

The second drive element 420 can be moved relative to the first drive element 410 in radial direction with respect to the first axis 407, so as to offset the second axis 406 from the first axis 407. Similar to the examples shown in FIGS. 4A-4D, the second drive element 420 is pivotably drivable about a pivot axis 426, which pivot axis 426 is parallel to the first axis 407. In this example, the pivot axis 426 coincides with the intermediate axis of the transmission system 10, which intermediate axis is here defined by the stationary mounting shaft 401. A rigid pivot arm 415, which extends between the mounting axis 401 and the connecting shaft 400 of the CVT unit 403, connects the second drive element 420 with the mounting shaft 401. The second drive element 420 is pivotably drivable at a constant radius from the mounting shaft 401. The constant radius is defined by the pivot arm 415. The primary gears 100A1 and 100B1 of the first transmission 100 are in this example mounted to the connecting shaft 400, which in turn is mounted or integrated with the second drive element 420. The primary gears 100A1 and 100B1 of the first transmission 100 are accordingly also pivotable together with the CVT output 405 about the pivot axis 426. Because, here, the secondary gears 100A2 and 100B2 of the first transmission are rotatingly associated with the pivot axis 426, the primary-secondary gear pairs 100A1-100A2 and 100B1-100B2 can remain meshingly engaged while the second drive element 420 is being pivoted about the pivot axis 426.

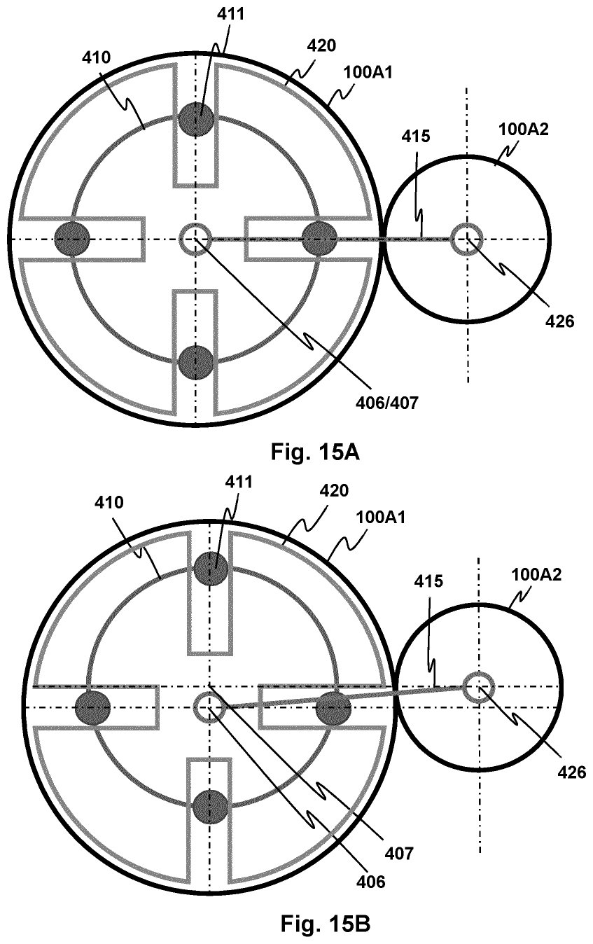

FIGS. 15A, 15B show a schematic of the pivoting of the second drive element 420 about the pivot axis 426, as described in view of FIGS. 14A, 14B.

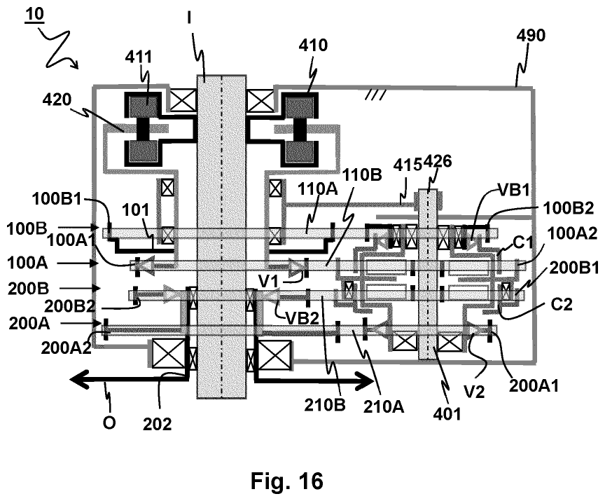

FIG. 16 shows an example of a gearless transmission system 1. The transmission system 10 in this example is similar to the example shown in FIG. 14A, but instead of gear drives for the first and second transmissions 100, 200, the first and second transmissions 100, 200 include belt drives for transmitting torque. In particular, the first transmission 100 comprises a first endless drive member 110A arranged in the first transmission path 100A, and a second endless drive member 110B arranged in the second transmission path 100B. The first and second endless drive members 110A, 110B, e.g. a first and second belt or chain, connect, respectively, a first and second primary wheel 100A1, 100B1, e.g. a primary sprocket, with a first and second secondary wheel 100A2, 100B2, e.g. a secondary sprocket.

In this example, the second transmission 200, similarly, comprises a third endless drive member 210A arranged in the third transmission path 200A, and a fourth endless drive member 210A arranged in the fourth transmission path 200B. The third and fourth endless drive members 210A, 210B, e.g. a third and fourth belt or chain, connect, respectively, a third and fourth primary wheel 200A1, 200B1, e.g. a primary sprocket, with a third and fourth secondary wheel 200A2, 200B2, e.g. a secondary sprocket. It will be appreciated that the any of the gear drives of the transmission systems described herein may also be configured as a belt drive. Similarly to as described in view of FIGS. 15A, 15B, the second drive element 420 is pivotably drivable at a constant radius from the mounting shaft 401; the constant radius being defined by the pivot arm 415.

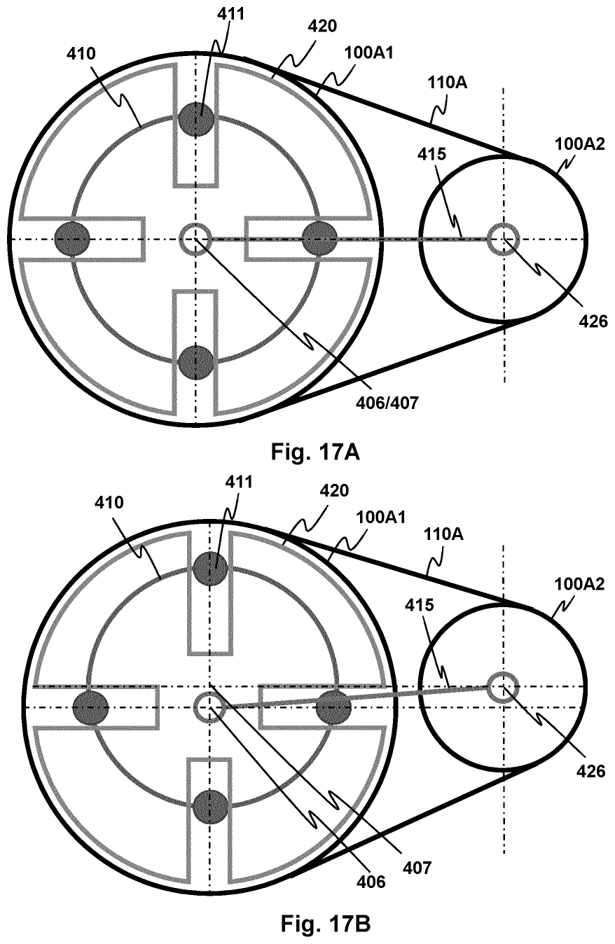

FIGS. 17A, 17B show a schematic of the pivoting of the second drive element 420 about the pivot axis 426 of the gearless transmission system 10 shown in FIG. 16. The primary wheels 100A1 and 100B1 of the first transmission 100 are in this example mounted to the connecting shaft 400, which in turn is mounted or integrated with the second drive element 420. The primary wheels 100A1 and 100B1 of the first transmission 100 are accordingly also pivotable together with the CVT output 405 about the pivot axis 426. Because, here, the secondary wheels 100A2 and 100B2 of the first transmission are rotatingly associated with the pivot axis 426, the primary-secondary wheel pairs 100A1-100A2 and 100B1-100B2 remain at a constant distance, when the second drive element 420 pivots about the pivot axis 426. Hence, the primary-secondary wheel pairs 100A1-100A2 and 100B1-100B2 wheel pairs can remain engaged by the respective endless drive members 110A, 120B, while the second drive element 420 is being pivoted about the pivot axis 426.

When, for example, driving the first drive member 410 in rotation about the first axis 407, the driving force is transferred by the first coupling elements 411 to the second drive element 420. This tangential force acts on the second drive element 420 in a substantially opposite direction as a reaction force from the endless drive member 110A. Hence, pivoting force for pivoting the primary wheel 100A1 along with the second drive element 420 about the pivot axis 426 can be reduced, at least with respect to the geared arrangement as shown in FIGS. 15A, 15B.

It will be appreciated that the schematic of FIGS. 17A, 17B can also apply to the exemplary hub assembly as shown in FIG. 8A, 8B, in which instead of the primary wheel 100A, a sprocket of the cassette of sprockets 491-496 is corotatingly mounted to the second drive element 420, and the hub shell 485 is mounted to the first drive element 410. Instead of the secondary wheel 100A2, a front chain wheel is provided which meshes with the chain 100A and transmits torque via the chain to the sprocket. Hence, in the example of FIG. 8A, 8B, the second drive element 420 is at the input of the CVT unit and the first drive element 410 is at the output. It will be appreciated that, for the hub assembly of FIGS. 8A, 8B, the pivot axis 426 does need not be coinciding with the front chain wheel axis. An additional chain tensioner could for example be provided for accommodating potential chain slack resultant from a relative movement between the first and second drive elements 410, 420.

The exemplary gearless transmission system 1, shown in FIG. 16 does not include meshing gears, and may accordingly be free of oil lubrication. No oil bath is present for lubricating rotational members of the transmission. Standard bearings, e.g. roller bearings, are used instead. There are in this example accordingly no need for oil seals to seal the housing 290. Instead of lubrication oil, a minimal amount of lubrication grease may be applied. The endless drive members and their associated wheels may even be completely free of lubrication.

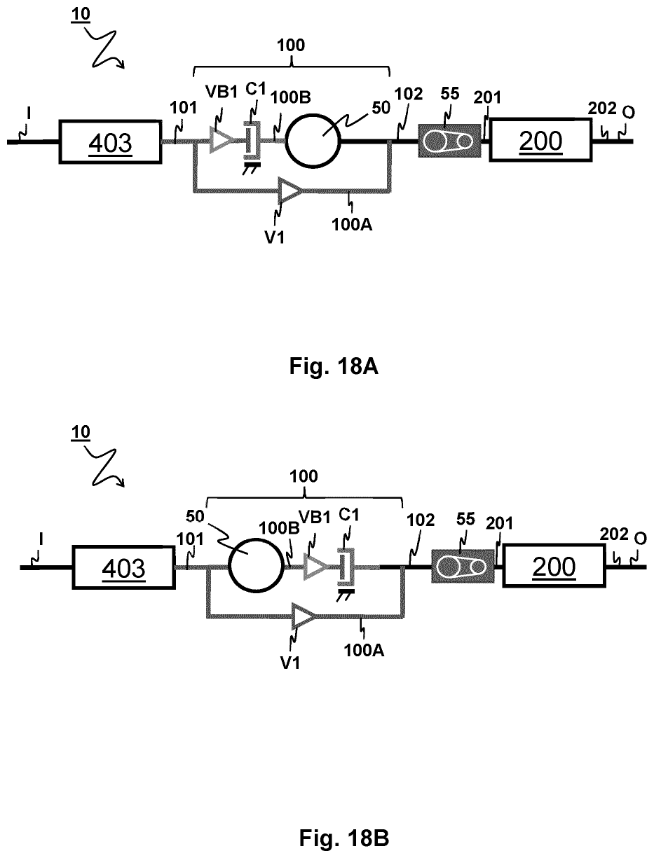

FIGS. 18A and 18B show exemplary transmission systems 10, wherein the CVT unit 403 is connected at an input side of the first transmission 100, and wherein the first transmission 100 includes a planetary gear set 50. Here the CVT 403 is connected in series to the first transmission 100. The planetary gear set is arranged in one of the transmission paths of the first transmission 100, here in the second transmission path 100B. The other transmission path, here the first transmission path 100A, is in this example provides a 1:1 transmission ratio. The first transmission 100 is, here, connected to the second transmission 200 via an endless drive member 55, e.g. a chain, belt, or cardan drive. It will be appreciated that the second transmission 200 and the endless drive member 55 may be omitted. In the exemplary arrangement of FIGS. 18A, 18B, the CVT unit 403 and the first transmission may be used as a crank transmission, e.g. between a crank and a front chain wheel of a bicycle, and the second transmission may be used as a hub transmission, e.g. between a rear sprocket and wheel hub of the bicycle. The endless drive member 55 may for example connect the front chain wheel and the rear sprocket, for transmitting torque from the front chain wheel to the rear sprocket.

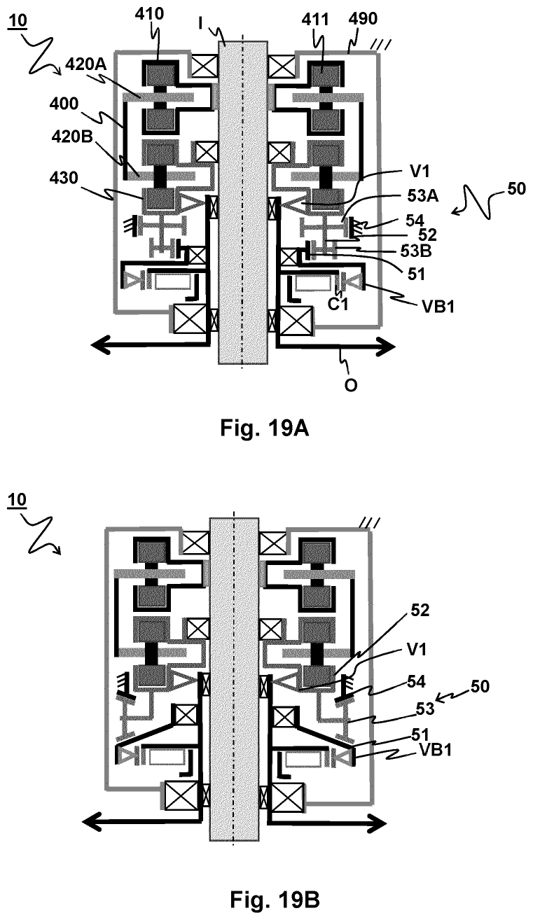

FIGS. 19A and 19B show exemplary transmission systems 10, particularly in accordance with the example of FIG. 18B. The planetary gear set 50 is concentrically arranged with respect to the input shaft I. The planetary gear set 50 includes at least three rotary members: here a sun gear 51, a planet carrier 52 carrying one or more planet gears 53, and a ring gear 54. Here, the planet carrier 52 is fixed to the CVT output, here formed by the third drive element 430, and corotates therewith about the input shaft I. The planet carrier 52 carries in this example multiple planet gears, such as two or three planet gears 53.

In the example of FIG. 19A, the planet gear rotation axes are parallel to the input axis 411, whereas in the example of FIG. 19B the planet gear rotation axes are arranged at an angle, particularly transverse, to the input shaft I.

The planet gears 53 in FIG. 19A are embodied as stepped planet gears. This way, a transmission ratio obtainable with the planetary gear can be increased, compared to arrangements with non-stepped planet gears. Hence, each planet gear 53 includes a large planet member 53A and a small planet member 53B being fixed to each other, and co-rotatable about a respective rotation axis. The large planet member 53A of the stepped planet gear engages the ring gear 54, whereas the small planet member 53B engages the sun gear 51.

The first transmission 100 is selectively operable according to two different transmission ratios R1, R2, wherein, here, R1=1.00 and R2=2.00. R2 is provided by the planetary gear set. With clutch C1, the first transmission 100 can switch between the first transmission path 100A and the second transmission path 100B. Clutch C1 can either be arranged at an input of the planetary gear set, or at an output of the planetary gear set 50.

Torque is transmitted from the CVT input, here formed by the first drive element 410, to the CVT output, here formed by the third drive element 430. The planet carrier 52 is fixed to the third drive element 430 and corotates therewith about the input shaft I. From the planet carrier 52, torque is transmitted via the stepped planet gears 53 to the sun gear 51, which in turn is couplable to the output O via clutch C1. If clutch C1 is decoupled, however, torque is not transmitted through the planetary gear set 50, but instead through the first transmission path 100A which bypasses the planetary gear set 50. Via the first transmission path 100A, torque is transmitted from the third drive element 430 to the output O via freewheel clutch V1.

The output O may optionally be connected to a further transmission, e.g. the second transmission 200, for example via an endless drive member 55, as shown in FIGS. 18A, 18B, however, it will be appreciated that the second transmission 200 and the endless drive 55 member may be omitted.

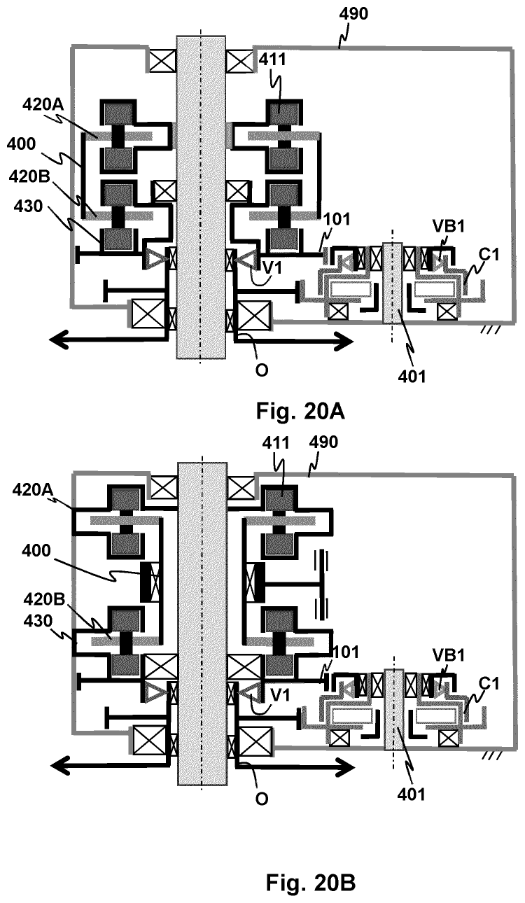

FIGS. 20A and 20B show examples of a transmission system 10, which may be offset alternative configurations to the examples shown in FIGS. 19A-19B. FIGS. 20A and 20B differ from each other in the configuration of the CVT unit 403, similar as described in view of FIGS. 14A and 14B.

Similar to the example of FIGS. 19A-19B, one transmission path of the first transmission 100 provides a 1:1 transmission ratio between the third drive element 430 and the output O, and another transmission path provides a non-unity transmission ratio, here a transmission ratio of 2.00. Instead of a coaxially arranged planetary gear set 50 as shown in FIGS. 19A and 19B, the second transmission path 100B extends via an offset intermediate axis, here defined by a stationary mounting shaft 401. Compared to the coaxial arrangement shown in FIGS. 19A, 19B, the examples of FIGS. 20A and 20B are relatively compact in axial direction. On the other hand, the coaxial arrangement of FIGS. 19A-19B is relatively compact in radial direction, compared to the offset arrangement of FIGS. 20A and 20B.

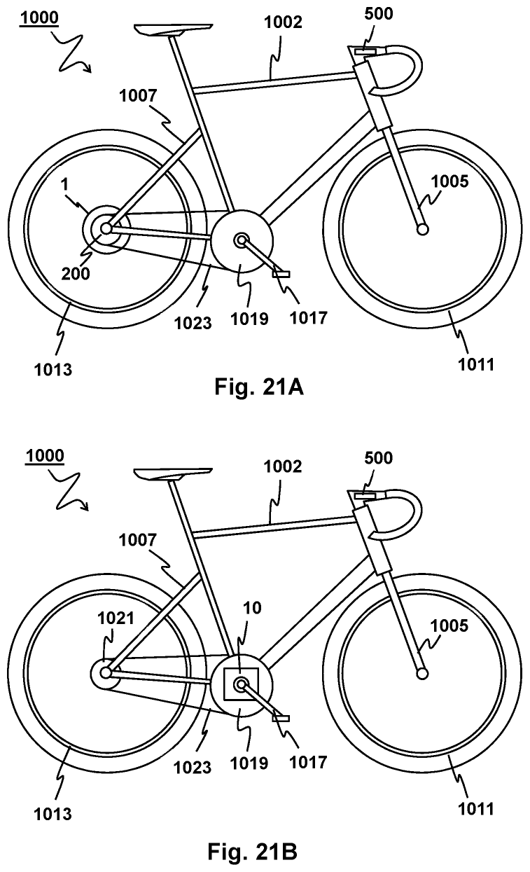

FIGS. 21A and 21B show a bicycle 1000. The bicycle 1000 comprises a frame 1002 with a front fork 1005 and a rear fork 1007, as well as a front wheel and a rear wheel 1011, 1013 located in the front and rear fork respectively. The bicycle 1000 further comprises a crank 1017, and a front chain wheel 1019. The bicycle 1000 also comprises a rear cassette of sprockets 1021, for example comprising one or more sprockets, wherein a chain 1023 threads over the front chain wheel 1019 and any one of the rear sprockets 1021.

In the example of FIG. 21A, the bicycle comprises a hub assembly 1 as shown in FIGS. 5A, 5B, 6A,6B, 7, 8A, 8B.

In the example of FIG. 18B, the bicycle comprises a transmission system as shown in FIGS. 9A,9B, 10A, 10B, 11, 12, 13, 14A, 14B, 15A, 15B, 16, 17A, 17B which is interconnected between the crank 1017 and front chain wheel 1019. It will be appreciated that the examples of FIGS. 21A and 21B can be combined.

The bicycle 1000 of FIGS. 21A, 21B also comprises a control unit 500, here connected to handlebars 1031, for controlling the transmission system of the bicycle. The control unit 500 can be configured to receive a first shift signal and a second shift signal, and to control the CVT unit 403, the first load-shifting clutch C1 and/or the second load-shifting clutch C2 for shifting gears accordingly in response to receiving the first and/or second shift signal. The shift signal may for example be sent, e.g. wirelessly, from a user interface, such as from a manual shifter device, e.g. at a handlebar of the bicycle, and/or one or more sensors, such as a torque sensor, speed sensor, cadence sensor and/or heart-rate monitor.

The first shift signal can be an upshift signal and the second shift signal can be a downshift signal. The control unit 500 can be configured to selectively control CVT unit 403, and also the first and/or second load-shifting clutch for selecting the next higher system transmission ratio in response to receiving the upshift signal, and for selecting the next lower system transmission ratio in response to receiving the downshift signal. The controller can also be configured to selectively control the first and/or second and/or third load-shifting clutch for selecting the second next, third next, fourth next, fifth next, sixth next, seventh next, eighth next higher or lower system transmission ratio in response to receiving a bail-out signal. The bail-out signal may for instance include the upshift signal and downshift signal at the same time, or within a specified time-interval.

The control unit 500 can thus be connected, e.g. wirelessly, to a first actuator for actuation of a relative motion between the first drive element 410 and the second drive element 420. The control unit 500 can also be connected, e.g. wirelessly, to a second actuator for actuating the first, e.g. load-shifting, clutch C1 and to a third actuator, e.g. wirelessly, for actuating the second, e.g. load-shifting, clutch C2. The CVT unit 403 may be operable according to any transmission ratio within a continuous set of transmission ratios. Each of the CVT transmission ratios may preprogrammed, and for example adapted to the transmission ratios of the first and second transmissions, 100, 200. A power supply may supply power, e.g. electric power, to the control unit 500 and the first, second and/or third actuators, and/or sensors. The power supply may for example comprise a battery.

The control unit 500 may also be arranged to operate the electric motor 450. The control unit 500 may for instance be configured to regulate an output power or output torque of the electric motor 450. The control unit 500 may also be configured to operate a clutch for coupling and decoupling the electric motor 450 from transmission system 10. The electric motor 450 may be powered from a separate power source. In FIGS. 18A, 18B, the bicycle 1000 does not comprise a front and rear derailleur, but it will be appreciated that a front and/or rear derailleur may be included.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. Continuously variable transmission unit, comprising:
a first drive element that is rotatable about a first axis;
a second drive element that is rotatable about a second axis parallel to the first axis, wherein the first drive element and the second drive element are movable relative to each other in a direction transverse to the first and second axis; and
first coupling elements provided at a constant first radius from the first axis and at a variable second radius from the second axis,
for transferring torque between the first drive element and the second drive element.

2. The transmission unit of claim 1, wherein the first coupling elements are coupled to the second drive element in a tangential direction, and movable relative to the second drive element in a radial direction,
wherein the first coupling elements are coupled to the first drive element in a radial direction at the first radius from the first axis, and movable relative to the first drive element in a first tangential direction, and
wherein the first coupling elements are couplable to the first drive element in a second tangential direction opposite the first tangential direction.

3. The transmission unit of claim 2, wherein the first drive element comprises a first concentric guide extending concentrically around the first axis, wherein the first concentric guide is arranged for guiding a movement of the first coupling elements in the first tangential direction.

4. The transmission unit of claim 3, wherein the first concentric guide and the first coupling elements form or include a one-way coupling for allowing movement of the first coupling elements relative to the first concentric guide in the first tangential direction, and for blocking movement of the first coupling elements relative to the first concentric guide in the second tangential direction opposite the first tangential direction.

5. The transmission unit of claim 4, wherein each of the first coupling elements comprises a wedging body which is tiltable about a tilt axis between a neutral position in which free movement of the coupling element relative to the first concentric guide is allowed, and a wedged position in which the wedging body is wedgingly engaged with the first concentric guide.

6. The transmission unit of claim 5, wherein each of the first coupling elements comprises at least one roller for activating the tilting of the wedging body from the neutral position to the wedged position.

7. The transmission unit of claim 6, wherein a first end of the wedging body is provided with a converging wedging recess for cooperating with a first roller and a second end of the wedging body, opposite the first end, is provided with a diverging wedging recess for cooperating with a second roller.

8. The transmission unit of any preceding claim, wherein the second drive element comprises first radial guides extending radially with respect to the second axis, wherein the first radial guides are arranged for guiding movement of the first coupling elements in radial direction and for transmitting torque in tangential direction.

9. The transmission unit of claim 8, wherein each of the first coupling elements comprises a guide wheel for running along the first radial guides.

10. The transmission unit of any preceding claim, wherein the continuously variable transmission comprises:
a third drive element that is rotatable about a third axis parallel to the second axis wherein the third drive element and the second drive element are movable relative to each other in a direction transverse to the third and second axis; and
second coupling elements provided at a constant third radius from the third axis and at a variable fourth radius from the second axis, for transferring torque between the third drive element and the second drive element.

11. The transmission unit of claim 10, wherein the second coupling elements are coupled to the second drive element in a tangential direction, and movable relative to the second drive element in a radial direction,
wherein the second coupling elements are coupled to the third drive element in a radial direction at the constant third radius from the third axis, and movable relative to the third drive element in the second tangential direction, and
wherein the second coupling elements are couplable to the third drive element in the first tangential direction.

12. The transmission unit of claim 11, wherein the third drive element comprises a second concentric guide extending concentrically around the third axis, wherein the second concentric guide is arranged for guiding a movement the second coupling elements in the third tangential direction.

13. The transmission unit of claim 12, wherein the second concentric guide and the second coupling elements form or include a one-way coupling allowing movement of the second coupling elements relative to the second concentric guide in the fourth tangential direction, and for blocking movement of the second coupling elements relative to the second concentric guide in the third tangential direction.

14. The transmission unit of claim 13, wherein each of the second coupling elements comprises a wedging body which is tiltable about a tilt axis between a neutral position in which free movement of the coupling element relative to the second concentric guide is allowed, and a wedged position in which the wedging body is wedgingly engaged with the second concentric guide.

15. The transmission unit of claim 14, wherein each of the second coupling elements comprises at least one roller for activating the tilting of the wedging body from the neutral position to the wedged position.

16. The transmission unit of claim 15, wherein a first end of the wedging body is provided with a converging wedging recess for cooperating with a first roller and a second end of the wedging body, opposite the first end, is provided with a diverging wedging recess for cooperating with a second roller.

17. The transmission unit of any of claims 10-16, wherein the second drive element comprises second radial guides extending radially with respect to the second axis, wherein the second radial guides are arranged for guiding movement of the second coupling elements in radial direction and for transmitting torque in tangential direction.

18. The transmission unit of claim 17, wherein each of the first coupling elements comprises a guide wheel for running along the first radial guides.

19. The transmission unit of any preceding claim, wherein the first axis and the third axis coincide.

20. The transmission unit of any preceding claim, wherein the second drive element is pivotally movable about a pivot axis that extends parallel to the first and second axes, for being pivotally moved relative to the first drive element in a direction transverse to the first and second axis, and/or wherein the first drive element is pivotally movable about a pivot axis that extends parallel to the first and second axes, for being pivotally moved relative to the second drive element in a direction transverse to the first and second axis.

21. The transmission unit of claim 20, comprising a second transmission wheel concentrically coupled to the second drive element and corotatable therewith about the second axis; and a first transmission wheel drivingly connected to the second transmission wheel for transmitting torque between the first and second transmission wheels, wherein the first transmission wheel has a rotation axis that coincides with the pivot axis.

22. The transmission unit of claim 21, comprising an endless drive member drivingly engaging the first transmission wheel and the second transmission wheel for transmitting torque from the first transmission wheel to the second transmission wheel and/or vice versa.

23. The transmission unit of claim 22, wherein the transmission unit is arranged for pivoting the second drive element between a concentric position in which the first and second axes coincide and an eccentric position in which the first and second axes are offset, and wherein
if the first drive element drives the second drive element in a driven rotation direction about the second axis: the transmission unit is arranged for pivoting the second drive element from the concentric position to the eccentric position in a rotation direction about the pivot axis opposite the driven rotation direction; and
if the second drive element drives the first drive element in a driven rotation direction about the first axis: the transmission unit is arranged for pivoting the second drive element from the concentric position to the eccentric position in the driven rotation direction about the pivot axis.

24. The transmission unit of any of claims 21-23, comprising a pivot arm for coupling the first transmission wheel to the second transmission wheel and delineate a constant distance between the second axis and the pivot axis, the pivot arm extending between a first end at which the pivot arm couples to the first transmission wheel at the pivot axis, and a second end at which the pivot arm couples to the second transmission wheel at the second axis.

25. The transmission unit of any of claims 21-24, comprising a fourth transmission wheel concentrically coupled to the second drive element and corotatable therewith about the second axis; and a third transmission wheel drivingly connected to the fourth transmission wheel for transmitting torque between the third and fourth transmission wheels, wherein the third transmission wheel has a rotation axis that coincides with the pivot axis.

26. The transmission unit of claim 25, wherein a torque transmission between first and second transmission wheels defines a first transmission path, and a torque transmission between the third and fourth transmission wheels defines a second transmission path, parallel to the first transmission path; and wherein the transmission system comprises a clutch for switching the torque transmission from the first transmission path to the second transmission path and/or vice versa.

27. Hub assembly for a bicycle, comprising a continuously variable transmission unit of any preceding claim.

28. Hub assembly of claim 27, comprising a hub shell for coupling to a driven wheel of the bicycle, the hub shell being coupled to the first drive element and corotatable therewith about the first axis; and a sprocket concentrically coupled to the second drive element and corotatable therewith about the second axis; or the hub shell being coupled to the second drive element and corotatable therewith about the second axis; and a sprocket concentrically coupled to the first drive element and corotatable therewith about the first axis.

29. Hub assembly of claim 27 when dependent at least on claim 10, comprising a hub shell for coupling to a driven wheel of the bicycle, the hub shell being coupled to the first drive element and corotatable therewith about the first axis; and a sprocket coupled to the third drive element and corotatable therewith about the third axis.

30. Crank assembly for a bicycle, comprising a continuously variable transmission unit of any of claims 1-25.

31. Crank assembly of claim 30, further comprising:
a first transmission, wherein the continuously variable transmission unit and the first transmission are connected in series,
a first transmission being selectively operable according to a first transmission ratio or a second transmission ratio, and having a first clutch for switching the first transmission from the first transmission ratio to the second transmission ratio and/or vice versa.

32. Gearless transmission unit, such as for a bicycle, providing at least two discrete selectable transmission ratios, wherein a first of the at least two transmission ratios is provided by a first endless drive member, and wherein a second of the at least two transmission ratios is provided by a second endless drive member.

33. Gearless transmission unit of claim 32, wherein the first and second endless drive members are placed in parallel between an input and an output of the gearless transmission unit, and the gearless transmission unit includes a selector for selecting power transmission via the first or the second endless drive member.

34. Gearless transmission unit of claim 32 or 33, including a clutch for selecting power transmission via the first endless drive member or the second endless drive member.

35. Gearless transmission unit of claim 32, 33 or 34, further including a third endless drive member and a fourth endless drive member, wherein the third and fourth endless drive members are placed in parallel between an output of the first and second endless drive members and an output of the gearless transmission unit, and the gearless transmission unit includes a selector for selecting power transmission via the third or the fourth endless drive member.

36. Gearless transmission unit of claim 35, including a clutch for selecting power transmission via the third endless drive member or the fourth endless drive member.

37. Gearless transmission unit of claim 36, wherein the clutch is arranged to be coupled and/or decoupled under load.

38. Gearless transmission unit of any of claims 32-37, wherein at least one of the first, second, third and fourth endless drive members is non-lubricated.

39. Gearless transmission unit of claim 38, wherein the at least one of the first, second, third and fourth endless drive members comprises a dry belt or dry chain.

40. Gearless transmission unit of any of claims 32-39, wherein at least one of the first, second, third and fourth endless drive members comprises a lubricated chain.

41. Gearless transmission unit of any of claims 32-40, including a continuously variable transmission, such as according to any of claims 1-26.

42. Hub assembly for a bicycle, including a gearless transmission unit of any of claims 32-41.

43. Crank assembly for a bicycle, including a gearless transmission unit of any of claims 32-41.

44. Bicycle, comprising a transmission unit of any of claims 1-26 or 32-41.
